(19) United States
(12) Patent Application Publication
(10) Pub. No.: US 2025/0045570 A1
(43) Pub. Date: Feb. 6, 2025

(54) ONLINE LEARNING SYSTEM WITH CONTEXTUAL BANDITS FEEDBACK AND LATENT STATE DYNAMICS

(71) Applicant: INTERNATIONAL BUSINESS MACHINES CORPORATION, Armonk, NY (US)

(72) Inventors: Elliot Nelson, Malvern, PA (US); Djallel Bouneffouf, Poughkeepsie, NY (US); Debarun Bhattacharjya, New York, NY (US); Tian Gao, Berkeley Heights, NJ (US); Miao Liu, Ossining, NY (US)

(21) Appl. No.: 18/228,742

(22) Filed: Aug. 1, 2023

(51) Int. Cl. G06N 3/047

(52) U.S. Cl. CPC G06N 3/047

(57) ABSTRACT

A method, computer program product, and computer system for triggering actions in a sequence of time steps within a multi-armed bandit process. In a current time step: a context input is received; a hidden Markov model (HMM) parameter transformation is executed to compute a latent state probability vector and HMM parameters using a conditional probability distribution, context input, values of latent state probability vector, and HMM parameters from a previous time step; an action is selected; an electromagnetic signal is sent to a hardware machine directing the hardware machine to perform the action; a dynamic reward resulting from the hardware machine having performed the action is received; a mean reward estimate as a function of the dynamic reward and the latent state probability is updated; and an update of the latent state probability vector in dependence on the dynamic reward, the action, and the mean reward estimate vector is computed.

### BACKGROUND

The present invention relates to a multi-armed bandit process, and more specifically, to a multi-armed bandit process that uses online expectation maximization (EM) algorithms for hidden Markov models to learn a latent transition model and maintain a posterior belief over a latent state.

### SUMMARY

Embodiments of the present invention provide a method, a computer program product, and a computer system for performing a method for triggering actions in a sequence of time steps within a multi-armed bandit process.

One or more processors of a computer system sequentially perform time steps t (t=0, 1, . . . , N), wherein N≥2.

Performing time step 0 comprises providing: an initial value \hat{p}₀ of a latent state probability vectorₜ of dimension Z respectively associated with Z specified latent states wherein Z≥2; an initial value(\hat{θ}₀, \hat{ϕ}₀) of Hidden Markov Model (HMM) parameters(\hat{θ}ₜ, \hat{ϕ}ₜ); and for each action (a) of K specified actions wherein K≥2: an initial value of a mean reward vector \hat{μ}^{(a)} of dimension Z.

The following steps are performed in time step t (t=1, 2, . . . , N).

A context (xₜ) is received from an external system that is external to the computer system. The context xₜ is one context of X specified contexts, wherein X≥2.

A HMM parameter transformation is executed to compute \hat{p}ₜ, \hat{θ}ₜ, and \hat{ϕ}ₜ, using a conditional probability distribution of p(xₜ|z, \hat{θ}ₜ₋₁) and inputs comprising xₜ or {xₜ}, \hat{p}ₜ₋₁, \hat{θ}ₜ₋₁, and \hat{ϕ}ₜ₋₁, wherein {xₜ} is x₁, x₂, . . . and xₜ.

An action (aₜ) is selected from the K actions. The action (aₜ) maximizes a function F(a) having a dependence on a reward estimate vector of dimension Z comprising the mean reward \hat{μ}^{(a)}ₜ or a stochastic reward estimate vector (\hat{μ}^{(a)}).

An electromagnetic signal is sent to a hardware machine. The electromagnetic signal directs the hardware to perform the selected action aₜ.

An identification of a dynamic reward (rₜ) resulting from the hardware machine having performed the selected action aₜ is received.

The mean reward estimate \hat{μ}^{(a}^{ₜ₎} is updated as a function of rₜ and \hat{p}ₜ.

An update of the latent state probability vector \hat{p}ₜ(z) is computed for each latent state z (z=1, 2, . . . , Z). The update of \hat{p}ₜ(z) comprises a dependence on rₜ or {rₜ}, aₜ, and \hat{μ}^{(a}^{ₜ₎}, wherein {rₜ} is r₁, r₂, . . . and rₜ.

### BRIEF DESCRIPTION OF THE DRAWINGS

FIG. 1 is a flow chart of an embodiment of a method for ascertaining final keywords derived from raw text of non-experts and experts, in accordance with embodiments of the present invention.

FIG. 2A is a graph depicting mean cumulative regret for a synthetic task with discrete categorical variables with shaded regions showing uncertainty in the mean over 10 episodes, in accordance with embodiments of the present invention.

FIG. 2B is a graph depicting mean cumulative regret results for a synthetic task with clustered contexts, in accordance with embodiments of the present invention.

FIG. 3A is a graph of mean cumulative regret in a Gaussian variable rover mining task with shaded areas showing uncertainty in the mean over 10 episodes, in accordance with embodiment of the present invention.

FIG. 3B is a graph of mean cumulative regret in a Gaussian variable rover mining task with a rarely changing latent state (nearly diagonal Φ*) with shaded regions showing uncertainty in the mean over 10 episodes, in accordance with embodiment of the present invention.

FIG. 4 is a flow chart of a method for triggering actions in a sequence of time steps within a multi-armed bandit process, in accordance with embodiments of the present invention.

FIG. 5 is a flow chart of a first embodiment for selecting an action, in accordance with embodiments of the present invention.

FIG. 6 is a flow chart of a second embodiment for selecting an action, in accordance with embodiments of the present invention.

FIGS. 7A-7E depict multiple embodiments of interaction among a computer system, an external system, and a hardware machine, in accordance with embodiments of the present invention.

FIG. 8 is a flow chart for updating the mean reward estimate, in accordance with embodiments of the present invention.

FIG. 9 illustrates a computer system, in accordance with embodiments of the present invention.

FIG. 10 depicts a computing environment which contains an example of an environment for the execution of at least some of the computer code involved in performing the inventive methods, in accordance with embodiments of the present invention

### DETAILED DESCRIPTION

### 1. Introduction

References cited herein are in and abbreviated form of Author(s), Date, and the detailed citations of such references are presented in Section 9.

In many real-world applications of multi-armed bandit problems, both rewards and contexts are often influenced by confounding latent variables which evolve stochastically over time. While the observed contexts and rewards are nonlinearly related, embodiments of the present invention use prior knowledge of latent causal structure to reduce the problem to a linear bandit setting.

Embodiments of the present invention provide two algorithms, Latent Linear Thompson Sampling (L²TS) and Latent Linear UCB (L²UCB), which use online expectation maximization (EM) algorithms for hidden Markov models to learn the latent transition model and maintain a posterior belief over the latent state, and then use the resulting posteriors as context features in a linear bandit problem. Embodiments of the present invention upper bound the error in reward estimation in the presence of a dynamical latent state, and derive a novel problem-dependent regret bound for linear Thompson sampling with non-stationarity and unconstrained reward distributions, which is applied to L²TS under certain conditions. A superiority of the inventive algorithms of the present invention over related bandit algorithms is demonstrated through experiments.

Multi-armed bandits have been successfully applied in domains such as healthcare [Durand et al., 2018; Zhu et al., 2018], finance [Shen et al., 2015], and recommender systems [Zhou et al., 2017].

Embodiments of the present invention pertain to contextual multi-armed bandit problems, where the presence of a latent variable is crucial for predicting rewards. Furthermore, it is typical in many real-world problems for additional complexity to arise in the form of latent variable non-stationarity (dynamics). Three illustrative real-world applications are as follows.

In a first real-world application, an interactive AI agent for personalized education chooses material to help a student's evolving state of knowledge, using observations such as the time taken to answer questions.

In a second real-world application, a rover on a mission explores blocks of land, taking samples for information about the ore grade and choosing real-time mining strategies for each block.

In a third real-world application, a recommender system selects items for users with evolving latent preferences or values, potentially using observable signals such as behavior patterns.

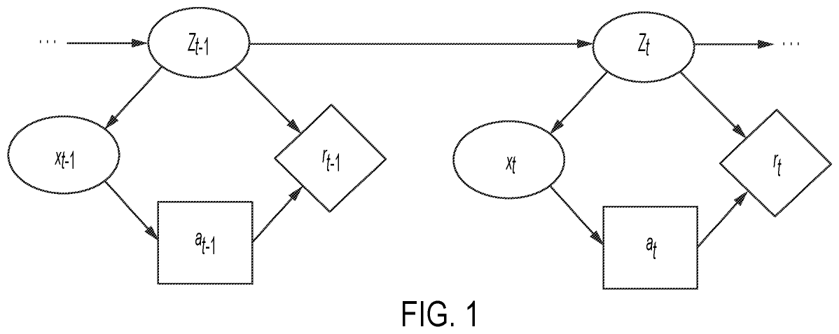

Such real-world applications can be represented with the graphical model of FIG. 1.

FIG. 1 is an influence diagram representation of the nonstationary version of a latent bandit setting, in accordance with embodiment of the present invention.

FIG. 1 depicts nodes (z, x, a, r) at times t−1 and t. A latent state z changes dynamically over time, while a context x is observed at a time of choosing action a. Reward r is a function of a and z. Nodes x, a and r (shaded) represent observed variable, and nodes z (unshaded) represent an unobserved variable.

In FIG. 1, a decision-making agent must use additional side information or context data (denoted x) for inference of an unseen, time-dependent latent state (denoted z), in order to improve reward predictions.

Embodiments of the present invention approach the non-stationary latent bandit problem of FIG. 1 by focusing on leveraging prior knowledge of the graphical structure to apply simpler methods to a difficult problem, using a strategy of reduction to a known problem. The linear multi-armed bandit setting [Auer, 2002 Abbasi Yadkori et al., 2011] has been studied extensively, leading to many algorithms and related theoretical guarantees. While complex real-world tasks generally involve nonlinear relationships between observed variables and target objectives (such as the nonlinear relationship between xₜ and rₜ in FIG. 1), expected values, and in particular expected rewards, are linearly related to probabilities of unknown variables or parameters. Embodiments of the present invention exploit this linear relationship, using algorithms and theoretical analyses for the linear bandit setting.

For the non-stationary bandit task of FIG. 1, posterior probabilities over the current latent state zₜ are maintained. FIG. 1 may also be viewed as a relation pertaining to an extension of a hidden Markov model (HMM) [Rabiner, 1989] into a multi-armed bandit task. Recognizing this relation, embodiments of the present invention leverage existing methods for online learning of HMMs. In particular, embodiments of the present invention utilize online EM which is an established method that learns to perform approximate Bayesian inference over the latent state.

Embodiments of the present invention combine existing methods for hidden Markov models and linear bandit problems in a novel way, to make the following contributions: (i) identification of conditions under which contextual multi-armed bandit problems with an evolving hidden state (FIG. 1) can be mapped to a linear bandit problem; (ii) introduction of novel bandit algorithms for the setting of FIG. 1, Latent Linear Thompson Sampling (L²TS) and Latent Linear Upper Confidence Bounds (L²UCB), which combine approximate online Bayesian inference over the latent state with linear bandit methods, and demonstration of superior performance compared to baseline algorithms; (iii) derivation of a high-probability bound (Theorem 1) on least-squares parameter estimation error in the setting of FIG. 1; and (iv) derivation, and application to L²TS (Theorem 2), of a novel problem dependent regret bound for linear Thompson sampling with non-stationary and arbitrary reward distributions.

### 2. Advantages Over Related Work

Next discussed are advantages of embodiments of the present invention and limitations of existing multi-armed bandit approaches in settings where a time-evolving latent state influences contexts and rewards.

Regarding linear bandits, embodiments of the present invention identify a path for applying methods and analysis for the linear bandit framework [Auer, 2002, Abbasi-Yadkori et al., 2011] to a larger class of (nonlinear) contextual bandit problems. Embodiments of the present invention introduce algorithms which use, as subroutines, the linear Thompson sampling algorithm of Agrawal and Goyal [2013b] or the related LinUCB algorithm [Li et al., 2010; Chu et al., 2011]. While linear bandit methods have been applied in various settings, embodiments of the present invention leverage linearity with respect to posterior probabilities which is novel, as well as apply the suite of linear bandit tools to latent bandit problems.

Regarding non-stationary bandits, the decision-making problem of FIG. 1 lies at the intersection of the (more general) class of contextual bandit problems, in which additional context information is available along with reward data, and the class of non-stationary bandit [Auer et al., 2003; Luo et al., 2018; Hartland et al., 2007; Garivier and Moulines, 2008; Yu and Mannor, 2009] problems, which introduce time dependence into the reward distribution. The bulk of existing work in non-stationary bandits focuses on detecting change in distributions or parameters [Luo et al., 2018]. The preceding methods cannot model the latent causal structure in embodiments of the present invention, which allows for improved modeling and prediction of distributional change over time.

Regarding non-stationary bandits, a growing body of research on latent bandit [Maillard and Mannor, 2014; Zhou and Brunskill, 2016] problems seeks to model reward distributions which are influenced by a latent state, as in FIG. 1. Most work in this area does not consider the case of dynamical state transitions. The graphical structure of FIG. 1 is considered in Hong et al. [2021], which in contrast to embodiments of the present invention, focuses on off-policy learning. Other recent work [Hong et al., Latent bandits revisited, 2020; Hong et al., Non-stationary latent bandits, 2020] considers a closely related problem in which a dynamical hidden state influences rewards, but assumes a different graphical structure in which contexts are unaffected by the latent state (and thus cannot be leveraged for inference of z). Similar to that of Hong et al. [2020], embodiments of the present invention use Thompson sampling [Thompson, 1933; Chapelle and Li, 2011; Russo and Roy, 2014] as an exploration heuristic. However, the approach of Hong et al. [2020] involves Thompson sampling of latent states as well as parameters. In settings where latent states changes occur frequently, such exploration of the latent space may not yield significant information gain before the state changes again, and can thus under-exploit. Furthermore, the practical algorithm proposed in Hong et al. [2020] uses particle filtering [Doucet et al., 2001], which can struggle to scale to higher dimensions with a fixed number of particles. In comparison, embodiments of the present invention sidestep the difficulties of approximating a high-dimensional posterior, by selectively maintaining uncertainty over the most task-relevant unknowns. Moreover, in the asymptotic limit of long sequences, the cumulative log-likelihood L(μ)= [symbol] ₜ log p(rₜ|aₜ; μ_{*}) of reward data becomes large, causing the posterior p(μ_{*})∝e^{L(μ}^{_{*)}} over reward parameters μ_{*} to satisfy the Laplace approximation and generally converge to a Gaussian form. Embodiments of the present invention exploit this asymptotic property with linear Thompson sampling [Agrawal and Goyal, 2013a], which uses a multivariate normal posterior.

Regarding recommender systems, the graphical structure of the problem, with a latent variable acting as a confounder of context observations and rewards, is shared in the literature on bandit algorithms for recommender systems (e.g. [Sen et al., 2017; Kawale et al., 2015]). In comparison to these works, which generally assume independent and identically distributed (i.i.d) latent variables, embodiments of the present invention provide an extension in the direction of non-stationarity.

As to causal bandits, embodiments of the present invention also relate to the burgeoning area of causal bandits [Lattimore et al., 2016] where causal mechanisms are explicitly modeled. Confounding from a latent variable was considered in Bareinboim et al. [2015], Lee and Bareinboim [2018], Sen et al. [2017], but under the assumption of i.i.d. data (no non-stationarity), and in an offline rather than online learning setting.

A discussion of related work on the subject of regret bounds is presented Section 3.3.

### 3. Problem Setting

Section 3: describes a contextual multi-armed bandit problem setting with a dynamical latent state (Section 3.1), describes a related linear bandit problem setting (Section 3.2), and shows that the latent bandit setting of Section 3.1 can be reduced to the linear bandit setting of Section 3.2 under certain conditions (Section 3.3).

### 3.1 Non-Stationary Latent Bandits

In the non-stationary bandit environment of FIG. 1, a dynamical latent state z acts as a confounder of observations (or contexts) x and rewards r. FIG. 1 is represented as an influence diagram, which is a graphical model for decision making under uncertainty [Howard and Matheson, 1984]. At any epoch, context x is observed before selecting action α, and reward r depends on α and z.

Although context is being expressed as a scalar for simplicity, the scope of embodiments of the present invention includes settings with high-dimensional observations of context.

While the context and reward may be either discrete or real-valued, the latent latent state z∈={1, . . . , Z} and action α∈A={1, . . . , K} are assumed to be discrete. The latent state z evolves stochastically according to a transition matrix Φ* (assumed to be ergodic)) with elements p(zₜ=z′|zₜ₋₁=z; ϕ*)=ϕ*_{z,z′}.

The equilibrium distribution for a given matrix Φ is the stationary distribution Φρ_{eq}(ϕ)=ρ_{eq}^{(ϕ)} (For any categorical distribution p(z), p∈R^{Z} denotes the vector whose elements are the probabilities p(z)). Given z, an observed context x is generated from a conditional distribution p(x|z; θ*) with parameters θ*. Lastly, rewards are generated from conditional distributions p(r|z, α) whose expected values are denoted as (\hat{μ}_{z}^{(a)})_{z}:=E[r|z,α], with μ_{*}^{(a)}∈R^{Z} being an action-wise vector of means, and variance as Var[r|z, α]. The action-wise parameter vectors are collectively denoted as \hat{μ}_{*:}={μ_{*}^{(a)}}_{α=1}^{K}.

Algorithms used in embodiments of the present invention rely on the estimation and use of a posterior belief, pₜ(z|x_{1:t}):=p(zₜ=z|x_{1:t}) over the current latent state, which is a categorical distribution represented as a Z-dimensional vector. A given transition model p(z′|z;\hat{ϕ}) and observation model p(x|z;\hat{θ}) can be updated every timestep with Bayes' rule:

$${\hat{p}}_{t} ( z \vert {x}_{1 : t} ) ∝ {\sum }_{{z}^{′}} {\hat{p}}_{t - 1} ( {z}^{′} \vert {x}_{1 : t - 1} ) {\hat{ϕ}}_{z , {z}^{′}} p ( {x}_{t} \vert z ; \hat{θ} ) \qquad ( 1 )$$

where the hat (\hat{ }) notation denotes model estimates.

The symbol ∝ is used in Equation (1) and elsewhere to denote equality up to a normalizing constant.

The model posterior is distinguished from the “true” posterior.

$${p}_{t}^{*} ( z ) := p ( {z}_{t} = z \vert {x}_{1 : t} ; {ϕ}^{*} , {θ}^{*} , {ρ}_{0} ) \qquad ( 2 )$$

which uses ground truth parameters and the true prior p*₀(z)=ρ₀(z).

A policy π is a mapping from partial histories (x_{1:t}, r_{1:t-1}, α_{1:t-1}) at any time t to probabilities of selecting each action, αₜ=α. The optimal policy π* is defined as the policy which selects, at every timestep, the action with highest expected reward, given the true parameters (but without accessing the true latent state); that is

$${a}_{r}^{*} := arg {{max}_{a} ( {p}_{t}^{*} )}^{T} {μ}_{*}^{( a )} .$$

Performance will be quantified with expected cumulative regret, defined, for any policy π, as the loss in expected rewards after T timesteps relative to the optimal policy: [symbol] n(T):=Σ_{t≤T} (E_{π}*[rₜ]−E_{π}[rₜ]).

### 3.2 Linear Bandits

Methods from the Linear bandit setting will be applied to the contextual latent bandit setting of Section 3.1, in which observations xₜ and reward rₜ are nonlinearly related. Embodiments of the present invention work with a slightly modified linear bandit setting as compared to the typical setting in the literature [Agrawal and Goyal, 2013b] in which at each timestep, a context feature vector cₜ ∈R^{d} is observed, an action aₜ=α is selected from K possible actions, and a reward with mean value cₜ^{T}μ_{*}^{(α)} is observed in accordance with Equation (3).

$${r}_{t} = {c}_{t}^{T} {μ}_{*}^{( a )} + {ε}_{t} \qquad ( 3 )$$

The random noise vector εₜ∈ [symbol] ^{d} has mean zero (i.e., E[εₜ]=0), but need not satisfy [symbol] any other conditions such as sub-Gaussianity or i.i.d. data across time. In order to maximize returns, the agent must use the sequential context data c_{1:t} to learn the unknown mean reward parameters μ_{*}^{(α)} ∈ [symbol] ^{d}f for each action α. In other variations of the linear bandit setting, the same parameters μ may be shared across actions, while a separate per-action context cₜ^{(a)} may be observed. Given the context cₜ, the corresponding optimal action is

$${a}_{t}^{*} := {a}^{*} ( {c}_{t} ) := arg {max}_{a} {c}_{t}^{T} {μ}_{*}^{( a )} .$$

Section 4 introduces introduce algorithms which use linear Thompson sampling (LinTS) [Agrawal and Goyal, 2013b] or LinUCB [Li et al., 2010, Chu et al., 2011] as subroutines. LinUCB and LinTS use observed contexts and rewards to maintain (for each action) a least-squares estimator:

$${\hat{μ}}^{( a )} = {( {B}^{( a )} )}^{- 1} {f}^{( a )} \qquad ( 4 )$$

where ƒ^{(α)}:=Σ_{t′=1}^{t}1(α_{t′}=α)c_{t′}r_{t′}, with 1(A) being the indicator function equal to 1(0) when A is true (false), and B^{(α)}:=λ_{μ} [symbol] d=Σ_{t′=1}ₜ1(α_{t′}=α)c_{t′}c_{t′}^{T}, is an empirical covariance matrix (λ_{μ}>0 is assumed to ensure invertibility). LinUCB uses the estimator covariance to compute upper confidence bounds, while LinTS uses each estimator \hat{μ}^{(α)} to Thompson sample from a multivariate Gaussian posterior, μ^{(α)}˜ [symbol] (\hat{μ}^{(a)}, (B^{(α)})⁻¹), and selects at each timestep the corresponding optimal action:

$${a}_{t} = arg {max}_{a} {c}_{t}^{T} {μ}_{*}^{( a )} .$$

### 3.3 Reduction to the Linear Bandit Problem

The linear relationship between rewards and probabilities over the latent space is exploited to show that the latent bandit problem of Section 3.1 can be reduced to the linear bandit setting of Section 3.2.

Lemma 1. When the true model parameters (θ*, ϕ*) and initial latent state probabilities ρ₀(z)=p(z₀=z) in the model from FIG. 1 are known, the latent bandit setting of Section 3.1 reduces to the linear bandit setting of Section 3.2.

Proof. Conditional on a sequence of observations x_{1:t} in the latent bandit setting and action αₜ=α, the reward rₜ is generated from the mixture distribution having the following form:

$$p ( {r}_{t} = r \vert {a}_{t} = a , {x}_{1 : t} ; {θ}^{*} , {ϕ}^{*} ) = {\sum }_{z} {( {c}_{t} )}_{z} p ( r \vert z , a ) ,$$

where cₜ ∈R^{Z} has been defined as the vector with elements equal to the posterior probabilities

$${( {c}_{t} )}_{z} := p ( {z}_{t} = z \vert {x}_{1 : t} ; {θ}^{*} , {ϕ}^{*} ) := {p}_{t}^{*} ( z ) . \qquad ( 5 )$$

The expected reward at time t is therefore

$$𝔼 [ {r}_{t} \vert {a}_{t} = a , {x}_{1 : t} ; {θ}^{*} , {ϕ}^{*} ] = {\sum }_{z} {( {c}_{t} )}_{z} {( {μ}_{*}^{( a )} )}_{z} = {c}_{t}^{T} {μ}_{*}^{( a )}$$

Thus, the reward takes the form of Equation (3), with d=Z being the number of latent states, cₜ defined in Eq. (5), and μ_{*}^{(α)} ∈ [symbol] ^{Z} being the vector of latent-conditioned mean rewards (μ_{*}^{(α)})_{z}.

Lemma 1 shows that the posterior belief over the current latent state zₜ can be viewed as a compression of the context history x_{1:t} into a (nonlinearly) transformed context variable which is related linearly to rewards. Since Lemma 1 assumes access to the true parameters (θ*, ϕ*), in general Lemma 1 will only apply in the asymptotic limit (t→∞) in which (θ*, ϕ*) have been learned. Prior to this asymptotic regime, error in model estimates of these parameters will corrupt the context features cₜ in the corresponding linear bandit problem with noise and/or systematic bias.

It is noted that the space of context vectors cₜ, or equivalently posterior beliefs p*ₜ (see Eq. (5)), is partitioned into subspaces, denoted [symbol] , for which action α* is optimal; i.e.,

$${a}^{*} = arg {max}_{a} {c}_{t}^{T} {μ}_{*}^{( a )} .$$

In the following Section 4, Lemma 1 will be built upon to develop a latent bandit algorithm which estimates rewards, Eq. (4), with contexts cₜ→p*ₜ as in Equation (5).

### 4. Latent Linear Bandit Algorithms

Since the non-stationary latent bandit problem of Section 3.1 can be reduced to the linear bandit setting as long as an accurate posterior belief over the latent state z can be maintained, algorithms for the latent bandit problem can be built by combining methods for approximate inference over z with linear bandit algorithms. Embodiments of the present invention introduce two specific such algorithms (Algorithm 1 depicted infra in Table 1 and Algorithm 2 depicted infra in Table 2), which use (i) Online Expectation Maximization (EM) for learning the parameters (θ*,φ*) of a hidden Markov model (and thus learning the “true” posteriors p*ₜ(z) assumed in Lemma 1), and (ii) either LinTS or LinUCB, into an end-to-end pipeline.

Latent State Inference. The online EM algorithm of Mongillo and Deneve [2008] is used for categorical context data, and the related Algorithm 1 of Cappe [2011] is used for continuous context data. As indicated in Algorithms 1 and 2 (presented infra), after observing xₜ these online EM algorithms recursively update (i) the vector estimate \hat{p}ₜ of latent state probabilities, (ii) sufficient statistics \hat{ψ}ₜ, and (iii) parameter estimates (\hat{θ}, ϕ) (determined by ψₜ). Further details, including the form of sufficient statistics \hat{ψ}ₜ for multinomial or Gaussian distributions, are provided in Section 7. Importantly, the approximate Bayes' update of the model posterior over the latent state, Equation (1), takes place as part of the online EM update. After observing the reward rₜ, the model posterior \hat{p}ₜ is again updated using a reward likelihood model p(r|z, α; \hat{μ}) which is either Bernoulli or Gaussian in some embodiments.

Thompson Sampling and UCB. As described in Section 3.3, the model posterior is used over the current latent state \hat{p}ₜ as a context feature vector in the linear bandit setting, cₜ=\hat{p}ₜ, and apply either linear Thompson Sampling [Agrawal and Goyal, 2013b](L²TS, Algorithm 1) or LinUCB [Li et al., 2010, Chu et al., 2011](L²UCB, Algorithm 2) as exploration heuristics to select actions. Like L²TS, L²UCB treats the posterior beliefs \hat{p}ₜ as context vectors in a linear bandit problem and uses the same reward estimators {(\hat{μ}^{(a)})} and covariance matrices proportional to (B^{(α)})⁻¹. The differences between L²TS and L²UCB are primarily in selecting the action aₜ in Algorithms 1 and 2. Note that L²UCB asymptotically selects the action aₜ with the highest expected reward \hat{p}ₜ^{T}\hat{μ}^{(a)}=E_{z} \hat{p}ₜ(z) \hat{μ}_{z}^{(a)} given the current posterior vector \hat{p}ₜ, and assigns an exploration bonus to actions whose reward estimates \hat{μ}_{z}^{(a)} have less certainty (in terms of the covariance matrix (proportional to (B^{(α)})⁻¹), for states z that have high probability \hat{p}ₜ (z).

While online EM only maintains point estimates (\hat{θ}, \hat{ϕ}), L²TS and L²UCB use exploration heuristics which leverage uncertainty in reward parameters {\hat{μ}^{(α)}} and in the current latent state zₜ. In comparison, the algorithm of Hong et al. [2020] also maintains Bayesian uncertainty over the transition matrix, requiring a more computationally intensive particle filtering implementation. The more computationally lightweight approach if embodiments of the present invention focuses on maintaining task-relevant uncertainty over (zₜ; μ_{*}) (see Section 2), and performed best empirically (Section 5). The computational complexity of L²TS and L²UCB is polynomial in the number of latent states Z (due to the online EM updates shown in Section 7); see Cappé [2011] for further discussion) and independent of the time t, making these algorithms scale well in problems with very long time horizons and low-dimensional latent structure.

TABLE 1
Algorithm 1: Latent Linear Thompson Sampling (L²TS)

```
Input:
  Prior over latent state, \hat{p}₀ ∈ [0,1]^{Z}
  Initial parameter estimates (\hat{θ}₀, \hat{ϕ}₀)
  Initial sufficient statistics \hat{ψ}₀
  f^{(a)} = 0_{Z}, \hat{μ}^{(a)} = 0_{Z}, for a ∈ A
  B^{(a)} = λ_{μ}1_{Z}, for a ∈ A; λ_{μ} > 0
  Likelihood variance \tilde{σ}ᵣ > 0
for t ← 1,2, ... do
  Observe xₜ;
  Update posterior \hat{p}ₜ and parameters (\hat{θ}, \hat{ϕ})
    (\hat{θ}ₜ, \hat{ϕ}ₜ, \hat{p}ₜ, \hat{ψ}ₜ) = OnlineEM (xₜ, \hat{θ}ₜ₋₁, \hat{ϕ}ₜ₋₁, \hat{p}ₜ₋₁, \hat{ψ}ₜ₋₁)
  Sample μ^{(a)} ~ N (\hat{μ}^{(a)}, \tilde{σ}ᵣ²(B^{(a)})⁻¹ for a ∈ A
  Select action aₜ = argmax _{a′} \hat{p}ₜ^{T} μ^{(a′)}
  Observe rₜ
  Update mean reward estimates:
      B^{(a}^{ₜ}⁾ ← B^{(a}^{ₜ}⁾ + \hat{p}ₜ\hat{p}ₜ^{T}
      f^{(a}^{ₜ}⁾ ← f^{(a}^{ₜ}⁾ + \hat{p}ₜ rₜ
      \hat{μ}^{(a}^{ₜ}⁾ = (B^{(a)})⁻¹ f^{(a}^{ₜ}⁾
  Update posterior:
        \hat{p}ₜ(z) ← [\hat{p}ₜ(z) p(rₜ | z, aₜ; \hat{μ}^{(a}^{ₜ}⁾) ] / Σ_{Z′} [\hat{p}ₜ(z′) p(rₜ | z′, aₜ; \hat{μ}^{(a}^{ₜ}⁾)]
```

TABLE 2
Algorithm 2: Latent Linear UCB (L²UCB)

```
Input:
  Prior over latent state, \hat{p}₀ ∈ [0,1]^{Z}
  Initial parameter estimates (\hat{θ}₀, \hat{ϕ}₀)
  Initial sufficient statistics \hat{ψ}₀
  f^{(a)} = 0_{Z}, \hat{μ}^{(a)} = 0_{Z}, for a ∈ A
  B^{(a)} = λ_{μ}1_{Z}, for a ∈ A; λ_{μ} > 0
  Exploration parameter α_{UCB} > 0
for t ← 1,2, ... do
  Observe xₜ;
  Update posterior \hat{p}ₜ and parameters (\hat{θ}, \hat{ϕ})
    (\hat{θ}ₜ, \hat{ϕ}ₜ, \hat{p}ₜ, \hat{ψ}ₜ) = OnlineEM (xₜ, \hat{θ}ₜ₋₁, \hat{ϕ}ₜ₋₁, \hat{p}ₜ₋₁, \hat{ψ}ₜ₋₁)
  Compute upper confidence bounds,
      πₐ = \hat{p}ₜ^{T} \hat{μ}^{(a)} + α_{UCB} [\hat{p}ₜ^{T} (B^{(a)})⁻¹ \hat{p}ₜ]^{1/2} for a ∈ A
      Select action aₜ = argmax _{a′} π_{a′}
  Observe rₜ
  Update mean reward estimates:
      B^{(a}^{ₜ}⁾ ← B^{(a}^{ₜ}⁾ + \hat{p}ₜ\hat{p}ₜ^{T}
      f^{(a}^{ₜ}⁾ ← f^{(a}^{ₜ}⁾ + \hat{p}ₜ rₜ
      \hat{μ}^{(a}^{ₜ}⁾ = (B^{(a)})⁻¹ f^{(a}^{ₜ}⁾
  Update posterior:
        \hat{p}ₜ(z) ← [\hat{p}ₜ(z) p(rₜ | z, aₜ; \hat{μ}^{(a}^{ₜ}⁾ ] / Σ_{Z′} [\hat{p}ₜ(z′) p(rₜ | z′, aₜ; \hat{μ}^{(a}^{ₜ}⁾)]
```

### 5. Experiments

In order to demonstrate the strong performance of algorithms used for embodiments of the present invention, experiments are conducted to compare the L²TS and L²UCB algorithms with relevant baselines on (i) discrete latent bandit tasks with synthetic data, and (ii) a Gaussian latent bandit problem for a mining application involving real data. In all cases, the true initial state distribution p*₀(z) differs at random from the model initial state distribution p₀(z).

### Multinomial Context and Reward Distributions.

Problem 1. In this problem, Z=2, K=2, and xₜ ∈{1, . . . , X} with X=4, and with

$${Φ}^{*} = ( \begin{matrix}0.9 & 0.1 \\ 0.1 & 0.9\end{matrix} ) .$$

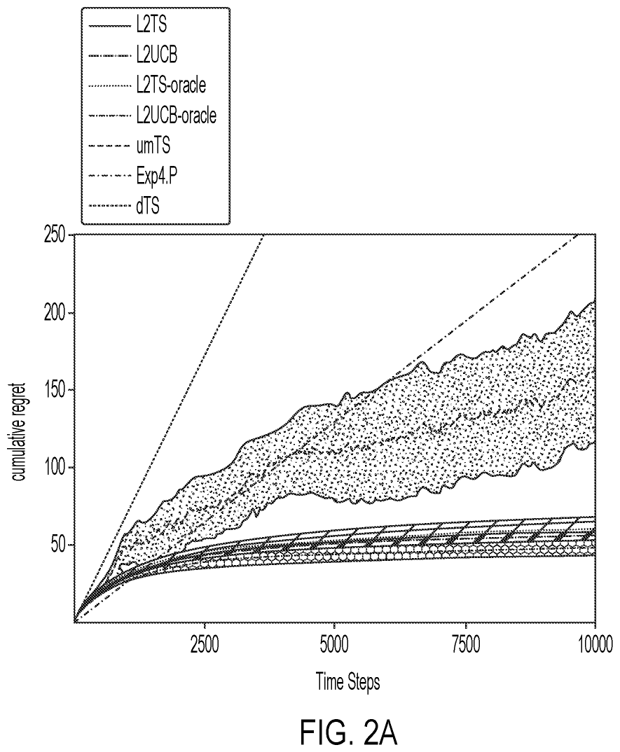

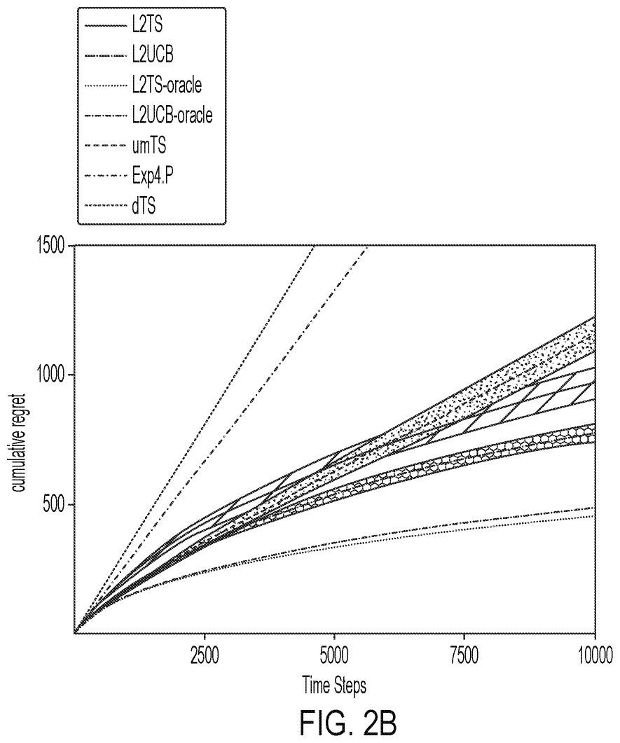

Five offline samples x˜p(x|z) for each z were used to improve the initial estimate at t=0 for both L²TS and L²UCB. FIG. 2A is a graph depicting mean cumulative regret for a synthetic task with discrete categorical variables with shaded regions showing uncertainty in the mean over 10 episodes, in accordance with embodiments of the present invention.

Problem 2. In this problem, (Z, X K)=(4, 12, 8), with Bernoulli reward probabilities sampled uniformly in (0,1), φ*_{z,z}=0.75 on-diagonal and uniform off-diagonal, and contexts clustered into groups which are only emitted by a single latent state. FIG. 2B is a graph depicting mean cumulative regret results for a synthetic task with clustered contexts, in accordance with embodiments of the present invention.

### Mining Application

A mining application where a rover explores and mines for oxide ore is considered. The rover travels over various blocks of land taking x-ray fluorescent meter samples (context x), which provide information about the oxide grade, which in turn depends on the presence of one of three latent geological classes (latent state z). Nonstationarity in this mining application is from spatial dependence between adjacent blocks of land. It is assumed that the rover chooses between two mining strategies for different minerals (actions a), such that there are varying reward probabilities depending on uncertain revenue from the mined ore as well as fixed and variable costs.

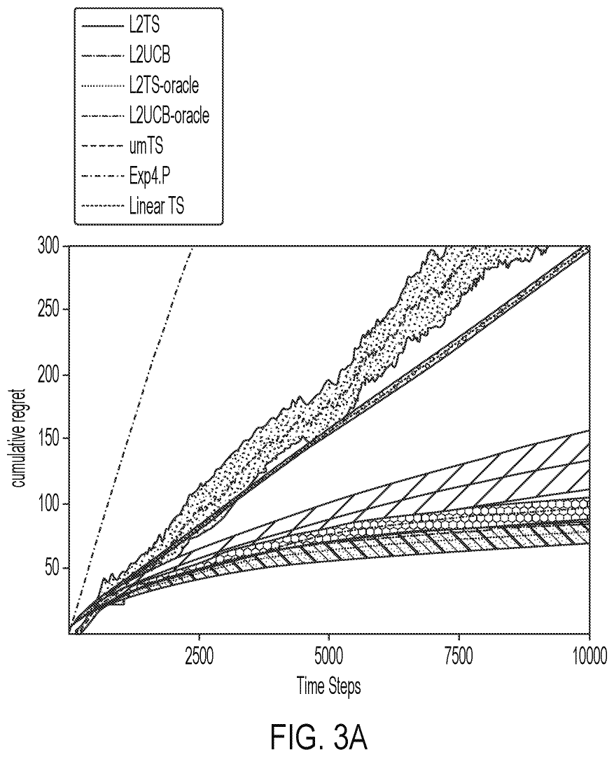

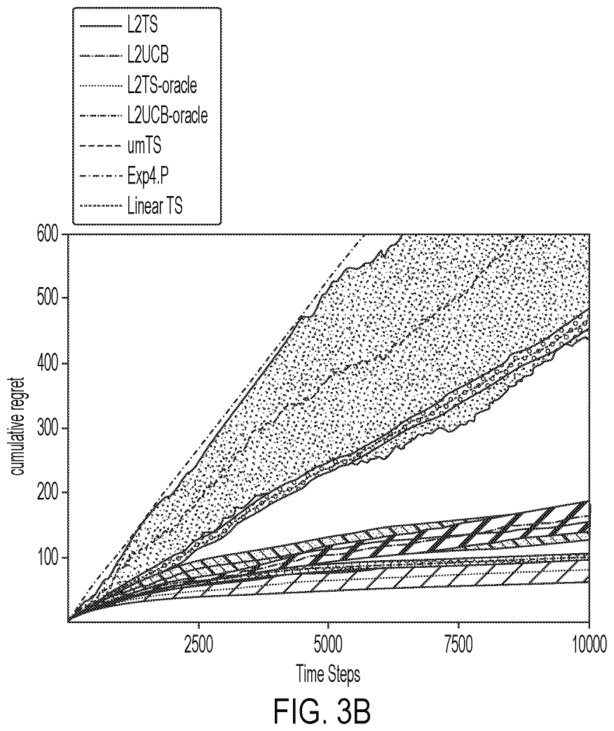

FIG. 3A is a graph depicting mean cumulative regret in a Gaussian variable rover mining task with shaded regions showing uncertainty in the mean over 10 episodes, in accordance with embodiments of the present invention.

FIG. 3B is a graph depicting mean cumulative regret in a Gaussian variable rover mining task with a rarely changing latent state (nearly diagonal Φ*) with shaded regions showing uncertainty in the mean over 10 episodes.

### Baselines

L²TS and L²UCB are compared with three baselines: (1) Uncertain Model Thompson Sampling (umTS): Algorithm 3 of Hong et al. [2020], which uses particle filtering to maintain a posterior over reward models, latent states, and latent transition matrices, is adapted to the setting of embodiments of the present invention by using oracle knowledge of p(xₜ|z; θ*) for additional posterior updates, which is denoted in FIGS. 2 and 3 with the label umTS*. (In the graphical setting of Hong et al. [2020], the latent state only influences rewards, and not contexts.); (2) Exp4.P [Beygelzimer et al., 2010]: Expert advisor classifiers trained (with varying latent state distributions) are used to label contexts x according to corresponding optimal actions and to modify the weight update of Exp4.P to discount the influence of old context data on current weights assigned to experts, and to use the true dynamics timescale to set the discount factor; (3) Discounted Thompson Sampling (dTS) [Raj and Kalyani, 2017]: dTS is extended to maintain success (r=1) and failure (r=0) counts for each discrete context-action pair (x,α), and (like Exp4.P) allow dTS to use the true dynamics timescale to set the discount factor γ. (dTS is only included in the experiment with discrete context variables.)

A comparison is also made to oracle variants of L²TS and L²UCB which use the true posterior p*ₜ (i.e. conditioned on the true parameters θ*, φ*, μ_{*}) instead of the estimate pₜ. As such, the oracle variants are simply linear Thompson sampling and LinUCB with uncorrupted or unbiased vectors cₜ=p*ₜ. For this reason, the L²TS oracle satisfies the conditions for Theorems 1 and 2. Lastly, in the rover mining experiment, a comparison is made to linear Thompson sampling using the raw contexts xₜ (instead of posteriors \hat{p}ₜ or p*ₜ).

### Results

FIGS. 2 and 3 show the cumulative regret for all algorithms, averaged over 10 episodes, for (respectively) the categorical-variable synthetic tasks and the Gaussian variable rover mining tasks. L²TS significantly outperforms baselines. While umTS models the true latent structure and is given additional prior knowledge of 0*, umTS struggles relative to the algorithms of the present invention except in the low-dimensional task (Problem 1), possibly due to challenges of scaling particle filtering to higher dimensions. Exp4.P suffers from asymptotically linear regret due to the inability Exp4.P to model the underlying latent dynamics. While Exp4.P can leverage statistical correlation between contexts and rewards that is modeled by its expert advisors, Exp4.P cannot learn the temporal structure of this correlation, which is governed by the latent state. Discounted TS performs most poorly in FIG. 2 due to the inability of Exp4.P to model the latent space or to transfer information gained across different discrete contexts. The poor performance of linear Thompson sampling relative to L²TS in FIG. 3 shows the benefit of using the (history-dependent) posterior probabilities pₜ as contexts for linear reward estimation, instead of the directly observed contexts xₜ. In most cases, the asymptotic performance of L²TS and L²UCB is comparable to their respective oracle variants (differing mainly in the overhead cost incurred at early times), indicating that approximation error in the learned transition probabilities and context distributions is under control.

### 6. Overview

Embodiments of the present invention present a novel multi-armed bandit algorithm for environments with a dynamical latent state influencing both observations (contexts) and rewards. The inventive algorithms of embodiments of the present invention use prior knowledge of latent graphical structure to transform a nonlinear and non-stationary contextual bandit problem into a linear bandit problem, exploiting the linearity between rewards and posterior probabilities over the latent state. While a specific method (Online EM) may be used to learn the latent transition matrix and context distributions, with specific linear bandit algorithms (LinTS, LinUCB), the high-level approach of treating a posterior belief over latent variables (or over unknown parameters) as context information is general and can be applied with any method for sequential Bayesian inference, and with other sequential decision-making algorithms. The theoretical analysis underlying embodiments of the present invention underscores the influence of the latent dynamics and distributional structure of the environment on task difficulty. Directions for future work include online learning of the latent space dimensionality, application of HMM learning convergence guarantees [Hsu et al., 2012] to non-stationary bandit problems, and extensions of the inventive methodology of the present invention to partially observable Markov decision process (POMDP) settings or to more complex graphical models.

### 7. Online Maximization. For Hidden Markov Models

The online EM algorithms used (by both L²TS and L²UCB) in experiments by inventors of the present invention are described in Sections 7.1-7.2. These online EM algorithms involve updating the model posterior over the latent state with Bayes' rule, using the current parameter estimates (\hat{θ}ₜ₋₁, (\hat{ϕ}ₜ₋₁), according to Equation (6).

$${\hat{p}}_{t} ( z ) ∝ {\hat{p}}_{t - 1} ( {z}^{′} ) {ϕ}_{z , {z}^{′}}^{( t - 1 )} p ( {x}_{t} \vert z ; {θ}^{( t - 1 )} ) \qquad ( 6 )$$

The updates according to Equation (6) are shown infra in Equations (7) and (11) in the special cases of multinomial and Gaussian context distributions, respectively.

In both cases (multinomial and Gaussian context distributions), online EM uses a discount factor γₜ∈(0, 1) which is used to control the magnitude of parameter estimate updates over time. The rate at which γₜ approaches zero as t→∞ controls the discounting of previously observed context data. In the experiments, γₜ=t^{-0.6} is used. While Gaussian distributions are focused upon in the case of continuous context data, the online EM algorithm of Cappé [2011] applies more generally to context distributions p(x|z) in the exponential family.

### 7.1 Multinomial Context Distributions

For multinomial context distributions with x∈{1, . . . , X}, θ={v_{j,k}} is defined where \hat{v}_{j,k}:=p(x=k|z=j) satisfies Σₖ₌₁^{X} \hat{v}_{j,k=1}. The algorithm of Mongillo and Deneve [2008], reproduced in Equations (7)-(10) infra, is used to implement the online EM update in L²TS (Algorithm 1) and L²UCB (Algorithm 2). OnlineEM (xₜ, \hat{θ}ₜ₋₁, ϕₜ₋₁, \hat{p}ₜ₋₁, \hat{ψ}ₜ₋₁) is defined as the function which returns (\hat{θ}ₜ, \hat{ϕ}ₜ, \hat{p}ₜ, \hat{ψ}ₜ), where (in the categorical case) \hat{θ}^{(t)}={\hat{v}_{j,k}^{(t)}}, \hat{ϕ}^{(t)}={\hat{ϕ}_{z,z′}^{(t)}}, and \hat{ψ}ₜ={\hat{ρ}_{i,j,h}^{(t)}(k)} are computed as in Equations (10), (9), and (8) respectively.

$${\hat{p}}_{t} ( z ) ∝ {\sum }_{{z}^{′}} {\hat{p}}_{t - 1} ( {z}^{′} ) {\hat{ϕ}}_{z , {z}^{′}}^{( t - 1 )} {\hat{v}}_{{z}^{′} , {x}_{t}}^{( t - 1 )} \qquad ( 7 )$$

$${\hat{ρ}}_{{i , j , h}_{}}^{( t )} ( k ) = {\sum }_{l} {Γ}_{l , h} ( {x}_{t} ) ( ( 1 - {γ}_{t} ) {\hat{ρ}}_{{i , j , l}_{}}^{( t - 1 )} ( k ) + {γ}_{t} 1 ( {x}_{t} = k ) 1 ( i = l ) 1 ( j = h ) {\hat{p}}_{t - 1} ( l ) ) where {Γ}_{i , j} ( {x}_{t} ) = {\hat{ϕ}}_{i , j}^{( t - 1 )} {\hat{v}}_{j , {x}_{t}}^{( t - 1 )} / [ {\sum }_{{i}^{′} , {j}^{′}} {\hat{ϕ}}_{{i}^{′} , {j}^{′}}^{( t - 1 )} {\hat{v}}_{{j}^{′} , {x}_{t}}^{( t - 1 )} {\hat{p}}_{t - 1} ( {i}^{′} ) ] \qquad ( 8 )$$

$${\hat{ϕ}}_{j , i}^{( t )} ∝ {\sum }_{k = 1}^{X} {\sum }_{h = 1}^{Z} {\hat{ρ}}_{{i , j , h}_{}}^{( t )} ( k ) \qquad ( 9 )$$

$${\hat{v}}_{j , k}^{( t )} ∝ {\sum }_{i , h = 1}^{Z} {\hat{ρ}}_{{i , j , h}_{}}^{( t )} ( k ) \qquad ( 10 )$$

In the updates to \hat{p}ₜ, \hat{ϕ}^{(t)} and \hat{v}^{(t)} supra, the ∝ sign indicates equality up to the normalizing factors required to ensure that Σ_{z} \hat{p}ₜ(z)=1, Σ_{z′} \hat{ϕ}_{z′,z}^{(t)}=1, and Σₖ₌₁^{X} \hat{v}_{j,k=1}.

### 7.1 Gaussian Context Distributions

For Gaussian context distributions p(x|z; \hat{θ}), the parameters are means and variances, \hat{θ}={\hat{v}_{z},\hat{Σ}_{z}}₁^{Z}, conditional on each latent state z. In this case, Algorithm 1 of Cappé [2011] is used to implement the online EM parameter update in L²TS. This algorithm is reproduced as follows, largely following the notation in Cappé [2011], with some modifications to maintain notation consistency with notation consistency. For simplicity, it is assumed that xₜ ∈ [symbol] so that \hat{v}_{z}^{(t)} is univariate. The expressions in Cappé [2011] apply also to the multivariate case.

OnlineEM (xₜ, \hat{θ}ₜ₋₁, \hat{ϕ}ₜ₋₁, \hat{p}ₜ₋₁, \hat{ψ}ₜ₋₁) is again defined as the function which returns (\hat{θ}ₜ, \hat{ϕ}ₜ, \hat{p}ₜ, \hat{ψ}ₜ), where, in the Gaussian case, \hat{θ}^{(t)}={\hat{v}_{z}^{(t)}, \hat{Σ}_{z}^{(t)}}, \hat{ϕ}^{(t)}={\hat{ϕ}_{z,z′}^{(t)}}, and \hat{ψ}ₜ={\hat{ρ}ₜ^{(ϕ)}(i,j,k), \hat{ρ}ₜ^{(θ)}(i, k)} are computed as in Equations (17), (15), and (13)-(14), respectively. These updates involve the quadratic sufficient statistic, s(x)=[1, x, x²], for context observations x˜p(·|z; θ*). In Equations (14) and (16) infra, \hat{ρ}ₜ^{(θ)} (i, k) shares the same vector dimension, which are indicated with bold symbols.

$${\hat{p}}_{t} ( z ) ∝ {\sum }_{{z}^{′} = 1}^{Z} {\hat{p}}_{t - 1} ( {z}^{′} ) {\hat{ϕ}}_{z , {z}^{′}}^{( t - 1 )} \frac{1}{\sqrt{2 π {\hat{\sum }}_{z}^{( t - 1 )}}} exp [ - {( {x}_{t} - {\hat{v}}_{z}^{( t - 1 )} )}^{2} / 2 {\hat{\sum }}_{z}^{( t - 1 )} ] \qquad ( 11 )$$

$${\hat{r}}_{t} ( z \vert {z}^{′} ) = [ {\hat{p}}_{t - 1} ( z ) {\hat{ϕ}}_{{z}^{′} , z}^{( t - 1 )} ] / [ {\sum }_{{z}^{″}} {\hat{p}}_{t - 1} ( {z}^{″} ) {\hat{ϕ}}_{{z}^{′} , {z}^{″}}^{( t - 1 )} ] \qquad ( 12 )$$

$${\hat{ρ}}_{{t}_{}}^{( ϕ )} ( i , j , k ) = {γ}_{t} 1 ( j = k ) + ( 1 - {γ}_{t} ) {\sum }_{{k}^{′} = 1}^{Z} {\hat{ρ}}_{{t - 1}_{}}^{( ϕ )} ( i , j , {k}^{′} ) {\hat{r}}_{t} ( {k}^{′} \vert k ) \qquad ( 13 )$$

$${\hat{ρ}}_{{t}_{}}^{( θ )} ( i , k ) = {γ}_{t} 1 ( j = k ) s ( {x}_{t} ) + ( 1 - {γ}_{t} ) {\sum }_{{k}^{′} = 1}^{Z} {\hat{ρ}}_{{t - 1}_{}}^{( θ )} ( i , {k}^{′} ) {\hat{r}}_{t} ( {k}^{′} \vert k ) \qquad ( 14 )$$

$${\hat{ϕ}}_{j , i}^{( t )} = [ {\sum }_{z = 1}^{Z} {\hat{ρ}}_{{t}_{}}^{( ϕ )} ( i , j , z ) {\hat{p}}_{t} ( z ) ] / {\sum }_{{z}^{′} , z = 1}^{Z} {\hat{ρ}}_{{t}_{}}^{( ϕ )} ( i , {z}^{′} , z ) {\hat{p}}_{t} ( z ) \qquad ( 15 )$$

$${\hat{S}}_{t}^{( θ )} ( i ) = {\sum }_{k = 1}^{Z} {\hat{ρ}}_{{t}_{}}^{( θ )} ( i , k ) {\hat{p}}_{t} ( k ) \qquad ( 16 )$$

$${\hat{v}}_{z}^{( t )} = {\hat{S}}_{t , 1}^{( θ )} ( z ) / {\hat{S}}_{t , 0}^{( θ )} ( z ) \qquad ( 17 )$$

$${\hat{\sum }}_{z}^{( t )} = {\hat{S}}_{t , 2}^{( θ )} ( z ) / {\hat{S}}_{t , 0}^{( θ )} ( z ) - {( {\hat{v}}_{z}^{( t )} )}^{2} \qquad ( 18 )$$

### 8. Inventive Methods

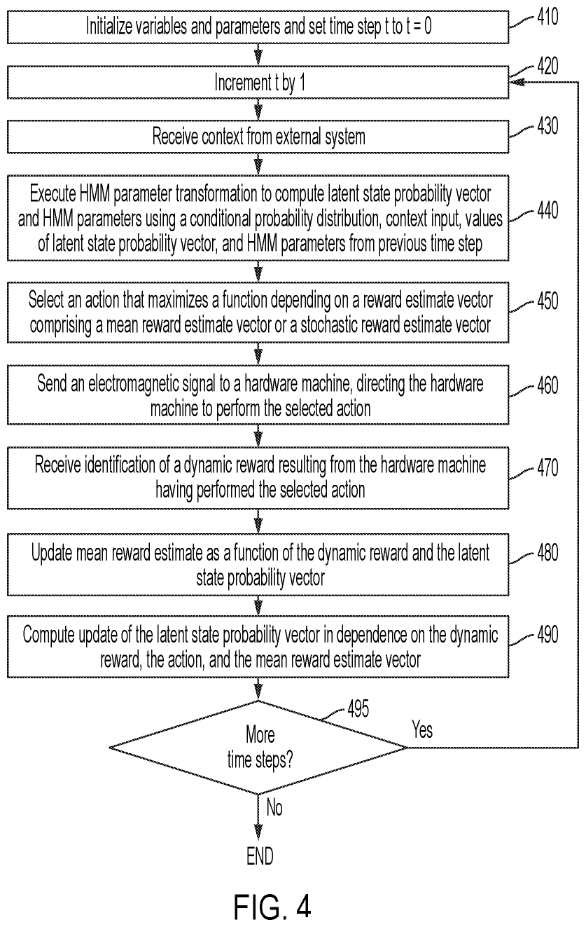

FIGS. 4-8 describe implementations of Algorithm 1 and Algorithm 2 as utilized in embodiments of the present invention.

Algorithm 1 uses linear Thompson sampling (LinTS). See Shipra Agrawal and Navin Goyal, Further optimal regret bounds for thompson sampling, In Proceedings of the International Conference on Artificial Intelligence and Statistics, pages 99-107, 2013a, incorporated herein by reference in its entirety, which may be obtained from a website link formed by a concatenation of the character strings of “http://” and “proceedings.mlr.press/v28/agrawal13.pdf”.

Algorithm 2 uses LinUCB. See Lihong Li,Wei Chu, John Langford, and Robert E. Schapire, A contextual-bandit approach to personalized news article recommendation, In Proceedings of the 19th International Conference on World Wide Web, page 661-670, 2010, incorporated herein by reference in its entirety, which may be obtained from a website link formed by a concatenation of the character strings of “https://” and “arxiv.org/abs/1003.0146”.

See also, Elliot Nelson, Debarun Bhattacharjya, Tian Gao, Djallel Bouneffouf, and Pascal Poupart, Proceedings of the 38th Conference on Uncertainty in Artificial Intelligence (UAI 2022), PMLR 180: Section 5, pages 1481-1483, incorporated herein by reference in its entirety, which may be obtained from a website link formed by a concatenation of the character strings of “https://” and “proceedings.mlr.press/v180/nelson22a/nelson22a.pdf”.

See also, Elliot Nelson, Debarun Bhattacharjya, Tian Gao, Djallel Bouneffouf, and Pascal Poupart, Accepted for the Conference on Uncertainty in Artificial Intelligence (UAI 2022), Sections B-D, pages 3-29, incorporated herein by reference in its entirety, which may be obtained from a website link formed by a concatenation of the character strings of “https://” and “proceedings.mlr.press/v180/nelson22a/nelson22a-supp.pdf”.

FIG. 4 is a flow chart of a method for triggering actions in a sequence of time steps within a multi-armed bandit process, in accordance with embodiments of the present invention.

The method of FIG. 4 includes steps 410-495.

Steps 410-495 include performing, by one or more processors of a computer system, time steps t (t=0, 1, . . . , N), wherein N≥2. Thus, the total number of time steps is N+1.

Step 410 initializes variables and parameters, and sets time step t to t=0. The variables and parameters initializations include: providing an initial value \hat{p}₀ of a latent state probability vector \hat{p}ₜ of dimension Z respectively associated with Z specified latent states wherein Z≥2; an initial value (\hat{θ}₀, \hat{ϕ}₀) of Hidden Markov Model (HMM) parameters (\hat{θ}ₜ, \hat{ϕ}ₜ); and for each action (a) of K specified actions wherein K≥2: an initial value of a mean reward vector \hat{μ}^{(a)} of dimension Z. In addition, step 410 may initialize some or all of the following parameters which may be used in various embodiments: ƒ^{(α)} (e.g., initialized to ƒ^{(α)}=0z), B^{(α)} (e.g., initialized to B^{(α)}=λ_{μ}1_{z}, λ_{μ}>0), exploration parameter α_{UCB}>0.

Steps 420-495 form a loop such that steps 420-495 are performed in a time step t.

Step 420 increments t by 1.

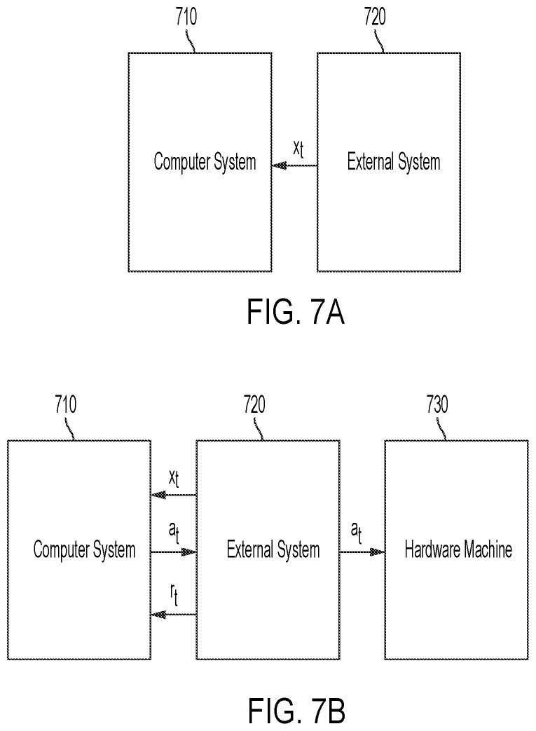

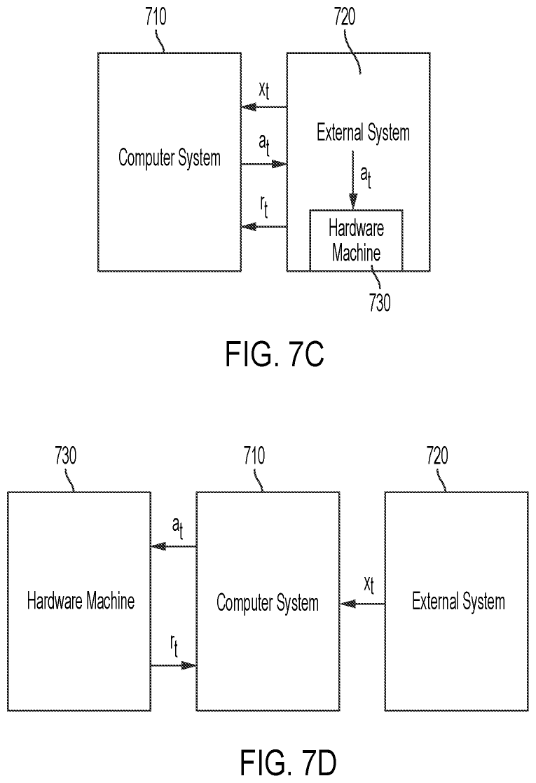

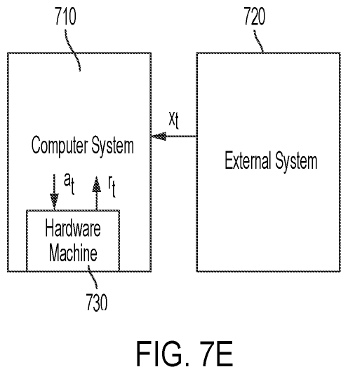

Step 430 receives, from an external system 720 that is external to the computer system 710 (see FIGS. 7A-7E discussed infra), a context (xₜ). The context xₜ is one context of X specified contexts, wherein X≥2.

Step 440 executes a HMM parameter transformation to compute \hat{p}ₜ, \hat{θ}ₜ, and \hat{ϕ}ₜ, using a conditional probability distribution p(xₜ|z, \hat{θ}ₜ₋₁) and inputs comprising xₜ or {xₜ}, \hat{p}ₜ₋₁, \hat{θ}ₜ₋₁, and \hat{ϕ}ₜ₋₁, wherein {xₜ} is x₁, x₂, . . . and xₜ.

In one embodiment, the inputs used to execute the HMM parameter transformation comprise xₜ, \hat{p}ₜ₋₁, \hat{θ}ₜ₋₁, and \hat{ϕ}ₜ₋₁.

In one embodiment, the inputs used to execute the HMM parameter transformation comprise {xₜ}, \hat{p}ₜ₋₁, \hat{θ}ₜ₋₁, and \hat{ϕ}ₜ₋₁.

In one embodiment, the HMM parameter transformation is an Online Expectation-Maximization (EM) algorithm used for executing the HMM parameter transformation.

In one embodiment, the conditional probability distribution p(xₜ|z,\hat{θ}ₜ₋₁) is a multinomial context distribution governed by Equations 7-10. See Gianluigi Mongillo and Sophie Deneve, Online learning with hidden markov models, Neural Computation, 20(7): 1706-1716, 2008, incorporated herein by reference in its entirety.

In one embodiment, the multinomial context distribution is utilized in the Online Expectation-Maximization (EM) algorithm used for implementing the executing the HMM parameter transformation.

In one embodiment, the conditional probability distribution p(xₜ|z,\hat{θ}ₜ₋₁) is a Gaussian context distribution governed by Equations 11-18. See Olivier Cappé, Online em algorithm for hidden markov models, Journal of Computational and Graphical Statistics, 20(3):728-749, 2011, incorporated herein by reference in its entirety.

In one embodiment, the Guassian context distribution is utilized in the Online Expectation-Maximization (EM) algorithm used for implementing the executing the HMM parameter transformation.

In one embodiment, executing the HMM parameter transformation computes \hat{p}ₜ, \hat{θ}ₜ, \hat{ϕ}ₜ, and \hat{ψ}ₜ using inputs comprising xₜ, \hat{p}ₜ₋₁, \hat{θ}ₜ₋₁, \hat{ϕ}ₜ₋₁, and \hat{ψ}ₜ₋₁, wherein \hat{ψ}ₜ denotes one or more aggregation parameters, and wherein performing time step 0 comprises providing an initial value \hat{ψ}₀ of \hat{ψ}ₜ.

Step 450 selects an action (aₜ) from the K actions. The action (aₜ) maximizes a function F(a) having a dependence on a reward estimate vector of dimension Z. The reward estimate vector is the mean reward estimate vector \hat{μ}^{(a)} or a stochastic reward estimate vector μ^{(a)}.

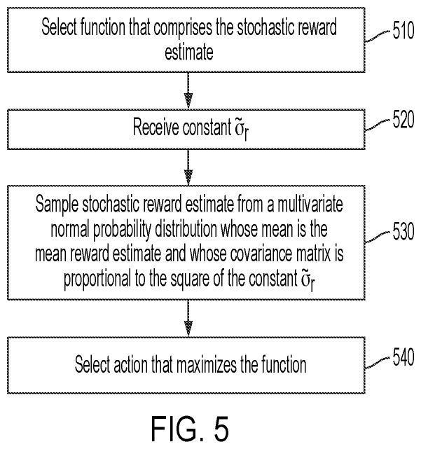

In a first embodiment, the function F(a) comprises the stochastic reward estimate vector (μ^{(a)}), and the action (aₜ) is selected as described infra in FIG. 5.

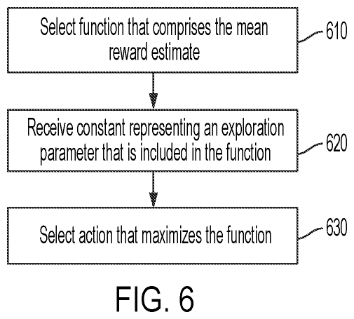

In a second embodiment, the function F(a) comprises the mean reward estimate vector (μ^{(a)}), and the action (aₜ) is selected as described infra in FIG. 6.

Step 460 sends an electromagnetic signal to a hardware machine. The electromagnetic signal directs the hardware machine 730 (see FIGS. 7A-7E described infra) to perform the selected action aₜ.

In one embodiment the electromagnetic signal is a wired signal (e.g., via cable).

In one embodiment the electromagnetic signal is a wireless signal via any of, inter alia, Wireless Fidelity (Wi-Fi), Bluetooth technology, Near Field Communication (NFC), Wireless Ethernet, etc.

In one embodiment, the hardware machine 730 is a computer.

In one embodiment, the hardware machine 730 is not a computer.

In one embodiment, the hardware machine 730 is not a generic computer.

In one embodiment, the hardware machine 730 is a specialized machine designed to perform specific functions with high efficiency and accuracy and are optimized for particular tasks, resulting in improved performance and/or reduced power consumption compared to general-purpose machines.

Examples of such specialized machine include, inter alia, an Application-Specific Integrated Circuit (ASIC) which is a custom-designed integrated circuit tailored to perform a specific application or task; Field-Programmable Gate Array (FPGA) which are semiconductor devices that can be programmed and reprogrammed to perform specific tasks after manufacturing; Neural Processing Unit (NPU) which is a specialized hardware accelerator designed to execute neural network models efficiently and may be used, inter alia, artificial (AI) applications; Tensor Processing Unit (TPU) which is a custom-designed AI accelerator optimized for executing machine learning workloads; Graphics Processing Unit (GPU) designed for rendering graphics and may be especially useful in parallel processing tasks due to their ability to handle a large number of calculations simultaneously; Digital Signal Processor (DSP) which is a specialized microprocessor optimized for processing digital signals, such as audio and video.

In one embodiment, the hardware machine 730 performs the action aₜ by performing a process selected from the group consisting of a mechanical process, an electrical process, a chemical process, a biological process, and any combination thereof.

Step 470 receives an identification of a dynamic reward (rₜ) resulting from the hardware machine having performed the selected action aₜ.

The latent states change randomly over time and are not impacted, or negligibly impacted, by the action aₜ.

Multiple embodiments of interaction among the computer system, the external system, and the hardware machine for implementing steps 430, 460, and 470 are described infra in FIGS. 7A-7E.

Step 480 updates the mean reward estimate \hat{μ}^{(a}^{ₜ₎} as a function of rₜ and \hat{p}ₜ.

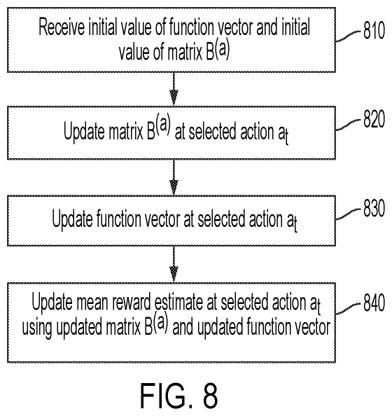

An embodiment for implementing step 480 to update the mean reward estimate \hat{μ}^{(a}^{ₜ₎} is described infra in FIG. 8

Step 490 computes an update of the latent state probability vector \hat{p}ₜ(z) for each latent state z (z=1, 2, . . . , Z). The update of \hat{p}ₜ(z) comprises a dependence on rₜ or {rₜ}, aₜ, and \hat{μ}^{(a}^{ₜ₎}, wherein {rₜ} is r₁, r₂, . . . and rₜ.

In one embodiment, the latent state probability vector \hat{p}ₜ(z) is updated in step 490 according to:

$${\hat{p}}_{t} ( z ) ← [ {\hat{p}}_{t} ( z ) p ( {r}_{t} \vert z , {a}_{t} ; {\hat{μ}}_{t}^{( a )} ) ] / {\sum }_{{z}^{′}} [ {\hat{p}}_{t} ( {z}^{′} ) p ( {r}_{t} \vert {z}^{′} , {a}_{t} ; {\hat{μ}}_{t}^{( a )} ) ] \qquad ( 19 )$$

Step 495 determines whether more time steps are to be executed. If so (Yes; t<N) then the method loops back to step 420 to perform the next time step. If not (No; t=N) then the method ends.

FIG. 5 is a flow chart of a first embodiment for selecting the action (aₜ) in step 450 of FIG. 1 in which the function F(a) comprises the stochastic reward estimate vector (μ^{(a)}), in accordance with embodiments of the present invention. The flow chart of FIG. 5 includes steps 510-540.

Step 510 selects the function F(a) that comprises the stochastic reward estimate vector (μ^{(a)}).

Step 520 receives a constant \tilde{σ}ᵣ. In one embodiment, the constant \tilde{σ}ᵣ may be received, inter alia, after having been provided in step 410 of FIG. 1 from input (e.g., user input) or after having been placed in data storage for subsequent usage or after having been initialized as a constant in program code that is executed to implement Algorithm 1.

Step 530 samples the stochastic reward estimate vector μ^{(a)} from a multivariate normal probability distribution whose mean is \hat{μ}^{(a)} and whose covariance matrix is \tilde{σ}ᵣ²(B^{(a)})⁻¹ for each action a of the K actions. B^{(a)} is a Z×Z matrix, wherein B^{(a)} is updated in each time step as a function of \hat{p}ₜ, wherein performing time step 0 further comprises providing an initial value of B^{(a)}.

In one embodiment, the multivariate normal probability distribution N(μ^{(a)}) is:

$$N ( {μ}^{( a )} ) = exp [ - 1 / 2 {( {μ}^{( a )} - {\hat{μ}}^{( a )} )}^{T} ( {{\tilde{σ}}_{r}^{2} ( {B}^{( a )} )}^{- 1} ) ( {μ}^{( a )} - {\hat{μ}}^{( a )} ) ] {/ [ {( 2 π )}^{Z} \vert {{\tilde{σ}}_{r}^{2} ( {B}^{( a )} )}^{- 1} \vert ]}^{1 / 2} \qquad ( 20 )$$

Step 540 selects the action (aₜ) that maximizes the function F(a)=\hat{p}ₜ^{T}μ^{(a)}.

FIG. 6 is a flow chart of a second embodiment for selecting the action (aₜ) in step 450 of FIG. 4 in which the function F(a) comprises the mean reward estimate vector (\hat{μ}^{(a}^{ₜ₎}), in accordance with embodiments of the present invention. The flow chart of FIG. 6 includes steps 610-630.

Step 610 selects the function F(a) that comprises the mean reward estimate vector (\hat{μ}^{(a}^{ₜ₎}).

Step 620 receives a constant α_{UCB} representing an exploration parameter. In one embodiment, the constant α_{UCB} may be received, inter alia, after having been provided in step 410 of FIG. 1 from input (e.g., user input) or after having been placed in data storage for subsequent usage or after having been initialized as a constant in program code that is executed to implement Algorithm 2.

Step 630 selects the action (αₜ) that maximizes the function F(a)=\hat{p}ₜ^{T}\hat{μ}^{(a)}+α_{UCB}(\hat{p}ₜ^{T}(B^{(a)})⁻¹\hat{p}ₜ)^{1/2}, wherein B^{(a)} is a Z×Z matrix, wherein B^{(a)} is updated in each time step as a function of \hat{p}ₜ, and wherein said performing time step 0 further comprises providing an initial value of B^{(a)}

FIGS. 7A-7E depict multiple embodiments of interaction among a computer system 710, an external system 720, and a hardware machine 730 for implementing steps 430, 460, and 470 of FIG. 4, in accordance with embodiments of the present invention.

FIG. 7A depicts the external system 720 sending a context xₜ to the computer system 710 in accordance with step 430 of FIG. 1.

FIGS. 7B-7D depict the computer system 710, the external system 720, and the hardware machine 730 in various configuration. In each configuration, the external system 720 sends a context xₜ to the computer system 710 in accordance with step 430 of FIG. 1.

In FIG. 7B, the hardware machine 730 is external to both the computer system 710 and the external system 720 and is communicatively coupled to the external machine 720. The computer system 710 sends an identification of the action aₜ indirectly to the hardware machine 730, by sending the identification of the action aₜ to the external system 720 followed by the external system 720 sending the identification of the action aₜ to the hardware machine 730. After the hardware machine 730 performs the action aₜ, the external machine sends to the computer system 710 the reward rₜ, or information sufficient for determining the reward rₜ, resulting from performance of the action aₜ by the hardware machine 730.

In FIG. 7C, the hardware machine 730 is internal within the external system 720. The computer system 710 sends an identification of the action aₜ to the hardware machine 730, by (i) sending the identification of the action aₜ directly to the hardware machine 730 or (ii) sending the identification of the action aₜ to a portion of the external system 720 that is external to the hardware machine 730 followed by the external system 720 sending the identification of the action aₜ directly to the hardware machine 730. After the hardware machine 730 performs the action aₜ, the external machine sends to the computer system 710 the reward rₜ, or information sufficient for determining the reward rₜ, resulting from performance of the action aₜ by the hardware machine 730.

In FIG. 7D, the hardware machine 730 is external to both the computer system 710 and the external system 720 and is communicatively coupled to the computer system 710. The computer system 710 sends an identification of the action aₜ directly to the hardware machine 730. After the hardware machine 730 performs the action aₜ, the hardware machine 730 sends to the computer system 710 the reward rₜ, or information sufficient for determining the reward rₜ, resulting from performance of the action aₜ by the hardware machine 730.

In FIG. 7E, the hardware machine 730 is internal within the computer system 710. The computer system 710 sends an identification of the action aₜ to the hardware machine 730. After the hardware machine 730 performs the action aₜ, the hardware machine communicates to the computer system 710 the reward rₜ, or information sufficient for determining the reward rₜ, resulting from performance of the action aₜ by the hardware machine 730.

FIG. 8 is a flow chart for implementing step 480 to update the mean reward estimate \hat{μ}^{(a}^{ₜ₎}, in accordance with embodiments of the present invention. The flow chart of FIG. 8 includes steps 810-840.

Step 810 receives an initial value of a function vector f^{(a)} of dimension Z and an initial value of B^{(a)}, wherein B^{(a)} is a Z×Z matrix.

In one embodiment, the initial value of the function vector f^{(a)} may be received, inter alia, after having been provided in step 410 of FIG. 1 from input (e.g., user input) or after having been placed in data storage for subsequent usage or after having been initialized as a constant in program code that is executed to implement Algorithm 1 or Algorithm 2.

In one embodiment, the initial value of the matrix B^{(a)} may be received, inter alia, after having been provided in step 410 of FIG. 1 from input (e.g., user input) or after having been placed in data storage for subsequent usage or after having been initialized as a constant in program code that is executed to implement Algorithm 1 or Algorithm 2.

Step 820 updates B^{(a}^{ₜ₎} at the selected action αₜ by adding \hat{p}ₜ \hat{p}ₜ^{T} to B^{(a}^{ₜ₎}.

Step 830 updates the function vector f^{(a}^{ₜ₎} by adding \hat{p}ₜrₜ to f^{(a}^{ₜ₎}.

Step 840 updates the mean reward estimate \hat{μ}^{(a}^{ₜ₎} according to \hat{μ}^{(a}^{ₜ₎}=(B^{(a}^{ₜ})⁻¹ f^{(a}^{ₜ₎}.

Tables 3-8 are Examples 1-6, respectively, which describe practical applications of embodiments of the present invention.

TABLE 3
Example 1

| | |
|---|---|
| Function of | selection of algorithm to run on a |
| Example | hardware device to perform a task |
| Hardware Machine | computer or specialized machine (e.g., |
| | ASIC, FPGA, NPU, TPU) |
| Context | some information about the task that |
| | the algorithm should solve, such |
| | as: a specification of performance |
| | metric (accuracy, time efficiency, |
| | etc.); resource constraints (memory |
| | or compute time availability; |
| | information about the dataset to be |
| | used, etc. |
| Latent States | unknown variables which influenced |
| | the generation of the dataset |
| | (which could come from another |
| | external environment which is |
| | changing in time) or which influence |
| | the state of the computer |
| | system that the selected algorithm |
| | will run on |
| Actions | selection of which of several |
| | algorithms (or computer programs) to |
| | run on the hardware machine, |
| | which could be, for example, machine |
| | learning algorithms along with |
| | a dataset |
| Rewards | performance (accuracy, efficiency, |
| | etc.) of the selected algorithm (or |
| | computer program) |

TABLE 4
Example 2

| | |
|---|---|
| Function of Example | control of robot to |
| | perform mechanical tasks |
| Hardware Machine | robot |
| Context | diagnostic information about the |
| | robot's physical location or |
| | immediate environment (time, lighting, |
| | temperature, weather, or |
| | anything that the robot could measure |
| | directly with the robot's |
| | sensors) |
| Latent States | underlying condition of the robot's |
| | immediate environment which |
| | can't be observed (e.g., in geological |
| | example, the latent states could |
| | be the type of earth or rock in the |
| | ground underneath the robot's |
| | location |
| Actions | selection of a strategy that the robot |
| | should use to perform a task |
| | (e.g. conservative vs. aggressive, |
| | quickly or slowly, etc.) |
| Rewards | evaluation of how successful the |
| | strategy was (e.g., whether the task |
| | was completed, or how quickly) |

TABLE 5
Example 3

| | |
|---|---|
| Function of Example | control of self-driving automobile |
| | using an on-board computer to |
| | execute the algorithms |
| Hardware Machine | self-driving automobile |
| Context | conditions at current location of |
| | automobile; e.g., visibility, road |
| | slipperiness, road quality or difficult |
| | terrain, traffic conditions, |
| | weather conditions (precipitation, wind |
| | speed), road inclination |
| | (sloping upward or downward) |
| Latent States | conditions ahead on the road (not at |
| | automobile's current |
| | location), e.g., road slipperiness, |
| | visibility, traffic conditions, etc. |
| Actions | changing lanes, accelerating or |
| | decelerating, passing slower |
| | moving vehicles, making turns (in |
| | particular, some actions are |
| | more conservative than others) |
| Rewards | optimizing fuel efficiency, |
| | minimizing travel time to reach |
| | destination |

TABLE 6
Example 4

| | |
|---|---|
| Function of Example | operation of a medical laser device |
| | during real-time removal of |
| | defective tissue of a patient |
| Hardware Machine | medical laser device |
| Context | characteristics of the tissue being |
| | treated (bleeding, color, swelling), |
| | patient data (blood pressure, pulse |
| | rate, oxygen level); environmental |
| | factors (lighting, temperature, humidity) |
| Latent States | patient comfort caused by environmental |
| | conditions (e.g., |
| | temperature, humidity); patient thoughts |
| | during laser treatment; |
| | actual time utilized in performing the |
| | action, by the medical laser |
| | device, in each time step; random error |
| | in parameter settings (power, |
| | pulse duration, spot size, or beam shape) |
| | in each time step |
| Actions | change laser parameter settings (power, |
| | pulse duration, spot size, or |
| | beam shape) in each time step |
| Rewards | minimize removal of healthy tissue, |
| | minimize duration of each time |
| | step and time of overall process |

TABLE 7
Example 5

| | |
|---|---|
| Function of | content recommendation |
| Example | |
| Hardware Machine | computer or specialized machine |
| | (e.g., ASIC, FPGA, NPU, TPU) |
| Context | public/shared information about |
| | the user (e.g., browsing history), or |
| | public/shared information about the |
| | task of the computer program/ |
| | algorithm that the content/data is |
| | being sent to, or about the hardware |
| | that is currently available |
| Latent States | preferences of the user, or private |
| | information about the task of the |
| | computer program/algorithm that the |
| | content/data is being sent to |
| | (could be from another party/client/company |
| | that only wants to share |
| | limited information with the bandit algorithm) |
| Actions | selection of content (articles or other text) |
| | or other information/data to |
| | send (maybe after retrieving from storage |
| | on a memory device) to the |
| | external system |
| Rewards | evaluation of usefulness of the content |
| | (could come from a human |
| | user, but could instead come from a computer |
| | system like a machine |
| | learning algorithm that uses the content for |
| | learning or prediction |
| | tasks) |

TABLE 8
Example 6

| | |
|---|---|
| Function of | health insurance plan selection |
| Example | |
| Hardware Machine | computer or specialized machine (e.g., |
| | ASIC, FPGA, NPU, TPU) |
| Context | any available information (e.g., RAF |
| | score) about the patient's health |
| | within the past time period (e.g., 1 year) |
| Latent States | patient's actual underlying health |
| | condition; e.g., “good”/“ok”/“bad” |
| | (determines likelihood of needing insurance |
| | coverage) |
| Actions | selection of insurance plan for patient, |
| | for some time period (e.g., 1 |
| | year) |
| Rewards | cost-efficiency of insurance plan |
| | (in light of health expenses in the |
| | time period) |

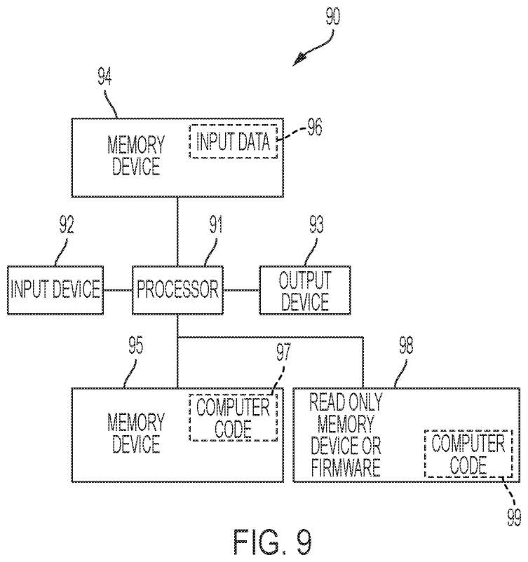

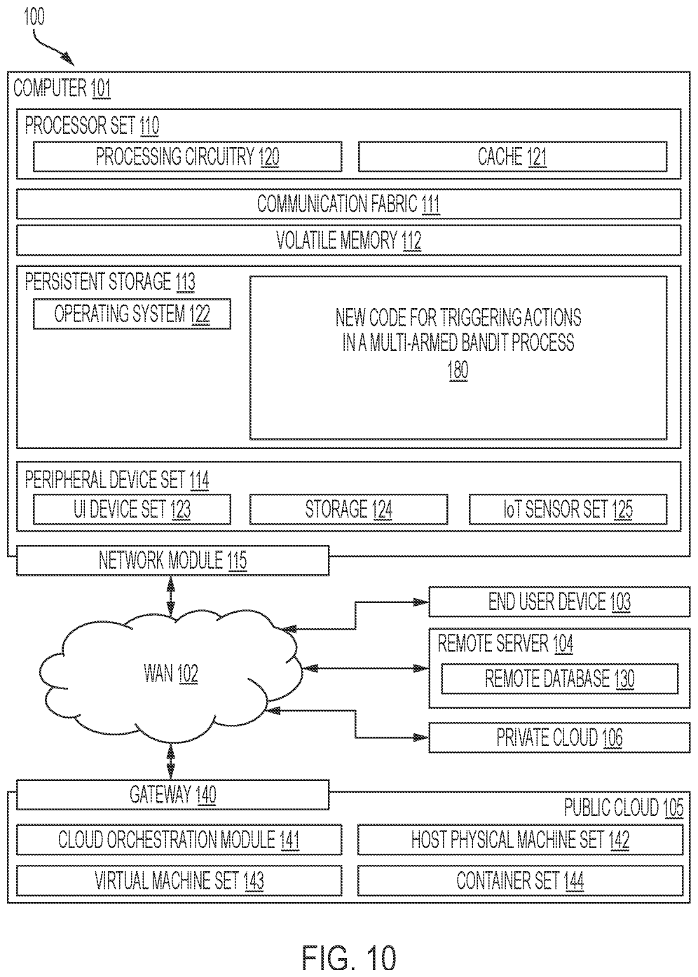

FIG. 9 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 10 depicts a computing environment 100 which contains an example of an environment for the execution of at least some of the computer code involved in performing the inventive methods, in accordance with embodiments of the present invention. Such computer code includes new code for triggering actions in a multi-armed bandit process 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 10. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### 9. List of References of References

Yasin Abbasi-Yadkori, Dávid Pál, and Csaba Szepesvári. Improved algorithms for linear stochastic bandits, In Advances in Neural Information Processing Systems, pages 2312-2320, 2011.
Shipra Agrawal and Navin Goyal. Further optimal regret bounds for thompson sampling, In Proceedings of the International Conference on Artificial Intelligence and Statistics, pages 99-107, 2013a.
Shipra Agrawal and Navin Goyal. Thompson sampling for contextual bandits with linear payoffs, In Proceedings of the International Conference on Machine Learning, pages 127-135, 2013b.
Peter Auer. Using confidence bounds for exploitation exploration trade-offs, Journal of Machine Learning Research, pages 397-422, 2002.
Peter Auer, Nicoló Cesa-Bianchi, Yoav Freund, and Robert E. Schapire. The nonstochastic multiarmed bandit problem. SIAM Journal of Computing, 32(1):48-77, January 2003. ISSN 0097-5397.
Elias Bareinboim, Andrew Forney, and Judea Pearl. Bandits with unobserved confounders: A causal approach. In Advances in Neural Information Processing Systems, pages 1342-1350, 2015.
Alina Beygelzimer, John Langford, Lihong Li, Lev Reyzin, and Robert E. Schapire. An optimal high probability algorithm for the contextual bandit problem, CoRR, abs/1002.4058, 2010. URL http://“concatenated with “arxiv.org/“_abs/1002.4058”.
Xavier Boyen and Daphne Koller, Tractable inference for complex stochastic processes, In Proceedings of the Fourteenth Conference on Uncertainty in Artificial Intelligence, page 33-42, 1998.
Olivier Cappé, Online em algorithm for hidden markov models, Journal of Computational and Graphical Statistics, 20(3):728-749, 2011.
Olivier Chapelle and Lihong Li, An empirical evaluation of Thompson sampling. In Advances in Neural Information Processing Systems, pages 2249-2257, 2011.

Wei Chu, Lihong Li, Lev Reyzin, and Robert Schapire, Contextual bandits with linear payoff functions, In AISTATS 2011, 2011.
A. Doucet, N. de Freitas, and N. Gordon, editors. Sequential Monte Carlo methods in practice, Springer, 2001.
Audrey Durand, Charis Achilleos, Demetris Iacovides, Katerina Strati, Georgios D. Mitsis, and Joelle Pineau, Contextual bandits for adapting treatment in a mouse model of de novo carcinogenesis, In Proceedings of the Machine Learning for Healthcare Conference, pages 67-82, 2018.
Jo Eidsvik, Tapan Mukerji, and Debarun Bhattacharjya, Value of Information in the Earth Sciences: Integrating Spatial Modeling and Decision Analysis, Cambridge University Press, 2015.
Aurélien Garivier and Eric Moulines, On upper-confidence bound policies for non-stationary bandit problems, arXiv e-prints, page arXiv:0805.3415, May 2008.
Cédric Hartland, Nicolas Baskiotis, Sylvain Gelly, Michéle Sebag, and Olivier Teytaud, Change point detection and meta-bandits for online learning in dynamic environments. In CAp 2007: 9é Conférence francophone sur l'apprentissage automatique, pages 237-250, July 2007.
Joey Hong, Branislav Kveton, Manzil Zaheer, Yinlam Chow, Amr Ahmed, and Craig Boutilier, Latent bandits revisited. In Advances in Neural Information Processing Systems, pages 13423-13433, 2020.
Joey Hong, Branislav Kveton, Manzil Zaheer, Yinlam Chow, Amr Ahmed, Mohammad Ghavamzadeh, and Craig Boutilier, Non-stationary latent bandits. arXiv e-prints, art. arXiv:2012.00386, December 2020.
Joey Hong, Branislav Kveton, Manzil Zaheer, Yinlam Chow, and Amr Ahmed. Non-stationary off-policy optimization, In Proceedings of The 24th International Conference on Artificial Intelligence and Statistics, volume 130 of Proceedings of Machine Learning Research, pages 2494-2502. PMLR, 2021.
Ronald Howard and James Matheson. Influence diagrams, In R. Howard and J. Matheson, editors, The Principles and Applications of Decision Analysis, volume II. Strategic Decisions Group, Menlo Park, CA, 2005.
Daniel Hsu, Sham M Kakade, and Tong Zhang, A spectral algorithm for learning hidden markov models, Journal of Computer and System Sciences, 78(5):1460-1480, 2012.
Jaya Kawale, Hung Bui, Branislav Kveton, Long Tran Thanh, and Sanjay Chawla, Efficient Thompson sampling for online matrix-factorization recommendation, In Advances in Neural Information Processing Systems, page 1297-1305, 2015.
Finnian Lattimore, Tor Lattimore, and Mark D. Reid. Causal bandits: Learning good interventions via causal inference, In Advances in Neural Information Processing Systems, pages 1181-1189, 2016.
Sanghack Lee and Elias Bareinboim. Structural causal bandits: Where to intervene? In Advances in Neural Information Processing Systems, pages 2573-2583, 2018.
Lihong Li, Wei Chu, John Langford, and Robert E. Schapire, A contextual-bandit approach to personalized news article recommendation, In Proceedings of the 19th International Conference on World Wide Web, page 661-670, 2010.
Haipeng Luo, Chen-Yu Wei, Alekh Agarwal, and John Langford, Efficient contextual bandits in non-stationary worlds. In Proceedings of the 31st Conference On Learning Theory, volume 75 of Proceedings of Machine Learning Research, pages 1739-1776, 2018.
Odalric-Ambrym Maillard and Shie Mannor, Latent bandits. In Proceedings of the International Conference on Machine Learning, pages 136-144, 2014.
Andres Munoz Medina and Scott Yang, No-regret algorithms for heavy-tailed linear bandits, In Proceedings of The 33rd International Conference on Machine Learning, volume 48, pages 1642-1650, 2016.
Gianluigi Mongillo and Sophie Deneve, Online learning with hidden markov models. Neural Computation, 20(7): 1706-1716, 2008.
Lawrence R. Rabiner, A tutorial on hidden Markov models and selected applications in speech recognition Proceedings of the IEEE, 77:257-286, 1989.
Vishnu Raj and Sheetal Kalyani, Taming non-stationary bandits: A Bayesian approach. arXiv preprint arXiv:1707.09727, 2017.
Daniel Russo and Benjamin Van Roy, Learning to optimize via posterior sampling. Mathematics of Operations Research, 39(4):949-1348, 2014.
Rajat Sen, Karthikeyan Shanmugam, Murat Kocaoglu, Alexandros G. Dimakis, and Sanjay Shakkottai, Latent contextual bandits: A non-negative matrix factorization approach. In Proceedings of the International Conference on Artificial Intelligence and Statistics, pages 518-527, 2017.
Weiwei Shen, Jun Wang, Yu-Gang Jiang, and Hongyuan Zha, Portfolio choices with orthogonal bandit learning. In Proceedings of the International Joint Conference on Artificial Intelligence, page 974-980, 2015.
William R. Thompson, On the likelihood that one unknown probability exceeds another in view of the evidence of two samples. Biometrika, 25(3-4):285-294, 12 1933.
Bo Xue, Guanghui Wang, Yimu Wang, and Lijun Zhang, Nearly optimal regret for stochastic linear bandits with heavy-tailed payoffs. In Proceedings of the Twenty-Ninth International Joint Conference on Artificial Intelligence, IJCAI'20, 2021
Jia Yuan Yu and Shie Mannor. Piecewise-stationary bandit problems with side observations, In Proceedings of the International Conference on Machine Learning, page 1177-1184, 2009.
Li Zhou and Emma Brunskill, Latent contextual bandits and their application to personalized recommendations for new users, In Proceedings of the International Joint Conference on Artificial Intelligence, pages 3646-3653, 2016.
Qian Zhou, XiaoFang Zhang, Jin Xu, and Bin Liang, Largescale bandit approaches for recommender systems, In Advances in Neural Information Processing Systems, pages 811-821, 2017.
Feiyun Zhu, Jun Guo, Ruoyu Li, and Junzhou Huang, Robust actor-critic contextual bandit for mobile health (MHealth) interventions. In Proceedings of the ACM International Conference on Bioinformatics, Computational Biology, and Health Informatics, page 492-501, 2018.

What is claimed is:

1. A method for triggering actions in a sequence of time steps within a multi-armed bandit process, said method comprising:
sequentially performing, by one or more processors of a computer system, time steps t (t=0, 1, . . . , N), wherein N≥2,
wherein performing time step 0 comprises providing: an initial value \hat{p}₀ of a latent state probability vectorₜ of dimension Z respectively associated with Z specified latent states wherein Z≥2; an initial value (\hat{θ}₀, \hat{ϕ}₀) of Hidden Markov Model (HMM) parameters (\hat{θ}ₜ, \hat{ϕ}ₜ); and for each action (a) of K specified actions wherein K≥2: an initial value of a mean reward vector \hat{μ}^{(a)} of dimension Z,
wherein performing time step t (t=1, 2, . . . , N) comprises:
receiving, from an external system that is external to the computer system, a context (xₜ), said context xₜ being one context of X specified contexts, wherein X≥2;
executing a HMM parameter transformation to compute \hat{p}ₜ, \hat{θ}ₜ, and \hat{ϕ}ₜ, using a conditional probability distribution p(xₜ|z,\hat{θ}ₜ₋₁) and inputs comprising xₜ or {xₜ}, \hat{p}ₜ₋₁, \hat{θ}ₜ₋₁, and \hat{ϕ}ₜ₋₁, wherein {xₜ} is x₁, x₂, . . . and xₜ.
selecting an action (aₜ) from the K actions, said action (aₜ) maximizing a function F(a) having a dependence on a reward estimate vector of dimension Z comprising the mean reward estimate \hat{μ}^{(a}^{ₜ₎} or a stochastic reward estimate vector (μ^{(a)};
sending an electromagnetic signal to a hardware machine, said electromagnetic signal directing the hardware to perform the selected action aₜ;
receiving an identification of a dynamic reward (rₜ) resulting from the hardware machine having performed the selected action aₜ;
updating the mean reward estimate \hat{μ}^{(a}^{ₜ₎} as a function of rₜ and \hat{p}ₜ; and
computing an update of the latent state probability vector \hat{p}ₜ(z) for each latent state z (z=1, 2, . . . , Z), said update of \hat{p}ₜ(z) comprising a dependence on rₜ or {rₜ}, aₜ, and \hat{μ}^{(a}^{ₜ₎}, wherein {rₜ} is r₁, r₂, . . . and rₜ.

2. The method of claim 1, wherein performing time step 0 comprises providing an initial value \hat{ψ}₀ of one or more aggregation parameters \hat{ψ}ₜ; and wherein said executing the HMM parameter transformation computes \hat{p}ₜ, \hat{θ}ₜ, \hat{ϕ}ₜ, and \hat{ψ}ₜ using inputs comprising xₜ, pₜ₋₁, \hat{θ}ₜ₋₁, \hat{ϕ}ₜ₋₁, and \hat{ψ}ₜ₋₁.

3. The method of claim 2, wherein said executing the HMM parameter transformation comprises executing an Online Expectation-Maximization (EM) algorithm.

4. The method of claim 1, wherein the inputs used to execute the HMM parameter transformation comprise xₜ, \hat{p}ₜ₋₁, \hat{θ}ₜ₋₁, and \hat{ϕ}ₜ₋₁.

5. The method of claim 1, wherein the inputs used to execute the HMM parameter transformation comprise {xₜ}, \hat{p}ₜ₋₁, \hat{θ}ₜ₋₁, and \hat{ϕ}ₜ₋₁.

6. The method of claim 1, wherein the function F(a) comprises the stochastic reward estimate vector (μ^{(a)}) of dimension Z, and wherein said selecting the action (aₜ) comprises:
sampling the stochastic reward estimate vector μ^{(a)} from a multivariate normal probability distribution whose mean is \hat{μ}^{(a)} and whose covariance matrix is \tilde{σ}ᵣ²(B^{(a)})⁻¹ for each action a of the K actions, wherein \hat{σ}ᵣ is a specified constant, wherein B^{(a)} is a Z×Z, wherein B^{(a)} is updated in each time step as a function of \hat{p}ₜ, and wherein said performing time step 0 further comprises providing an initial value of B^{(a)}, and; and
selecting the action (aₜ) that maximizes the function F(a)=\hat{p}ₜ^{T}μ^{(a)}.

7. The method of claim 1, wherein function F(a) comprises the mean reward estimate \hat{μ}^{(a}^{ₜ₎}, and wherein said selecting the action (aₜ) comprises:
selecting the action (αₜ) that maximizes the function F(a)=\hat{p}ₜ^{T}μ^{(a)}+α_{UCB}(\hat{p}ₜ^{T}(B^{(a)})⁻¹\hat{p}ₜ)^{1/2}, wherein α_{UCB} is a specified constant representing an exploration parameter, wherein B^{(a)} is a Z×Z matrix, wherein B^{(a)} is updated in each time step as a function of \hat{p}ₜ, and wherein said performing time step 0 further comprises providing an initial value of B^{(a)}.

8. The method of claim 1, wherein said performing time step 0 comprises receiving an initial value of a function vector f(a) of dimension Z and an initial value of B^{(a)}, wherein B^{(a)} is a Z×Z matrix, and wherein said updating the mean reward estimate \hat{μ}^{(a}^{ₜ₎} comprises:
updating B^{(a}^{ₜ₎} at the selected action aₜ by adding \hat{p}ₜ \hat{p}ₜ^{T} to B^{(a}^{ₜ₎};
updating the function vector f^{(a}^{ₜ₎} by adding \hat{p}ₜ rₜ to f^{(a}^{ₜ₎}; and
updating the mean reward estimate \hat{μ}^{(a}^{ₜ₎} according to \hat{μ}^{(a}^{ₜ₎}=(B^{(a}^{ₜ₎})⁻¹f^{(a}^{ₜ₎}.

9. The method of claim 1, wherein said computing the update of pₜ(z) comprises:
computing a Bayesian update of \hat{p}ₜ(z) based on a specified conditional probability p(rₜ|z, aₜ; \hat{μ}^{(a}^{ₜ₎}.

10. The method of claim 1, wherein p(xₜ|z,\hat{θ}ₜ₋₁) is a multinomial context distribution.

11. The method of claim 1, wherein p(xₜ|z,\hat{θ}ₜ₋₁) is a Gaussian context distribution.

12. The method of claim 1, wherein the update of \hat{p}ₜ(z) comprises a dependence on rₜ, aₜ, and \hat{μ}^{(a}^{ₜ₎}.

13. The method of claim 1, wherein the update of \hat{p}ₜ(z) comprises a dependence on {rₜ}, aₜ, and \hat{μ}^{(a}^{ₜ₎}.

14. The method of claim 1, wherein the hardware machine is not a generic computer.

15. The method of claim 1, wherein the hardware machine is a computing device.

16. The method of claim 1, wherein the hardware machine is an Application-Specific Integrated Circuit (ASIC), a Field-Programmable Gate Array (FPGA), a Neural Processing Unit (NPU), a Tensor Processing Unit (TPU), Graphics Processing Unit (GPU), or Digital Signal Processor (DSP).

17. The method of claim 1, wherein the external system comprises the hardware machine.

18. The method of claim 16, wherein said sending the signal comprises transmitting the electromagnetic signal indirectly to the hardware machine in the external system via a computing device in the external system, said computing device configured to receive the transmitted electromagnetic signal and to subsequently send the transmitted electromagnetic signal to the hardware machine.

19. A computer program product, comprising one or more computer readable hardware storage devices having computer readable program code stored therein, said program code containing instructions executable by one or more processors of a computer system to implement a method for triggering actions in a sequence of time steps within a multi-armed bandit process, said method comprising:
sequentially performing, by the one or more processors, time steps t (t=0, 1, . . . , N), wherein N≥2,
wherein performing time step 0 comprises providing: an initial value \hat{p}₀ of a latent state probability vectorₜ of dimension Z respectively associated with Z specified latent states wherein Z≥2; an initial value (\hat{θ}₀, \hat{ϕ}₀) of Hidden Markov Model (HMM) parameters (\hat{θ}ₜ, \hat{ϕ}ₜ); and for each action (a) of K specified actions wherein K≥2: an initial value of a mean reward vector \hat{μ}^{(a)} of dimension Z,
wherein performing time step t (t=1, 2, . . . , N) comprises:
receiving, from an external system that is external to the computer system, a context (xₜ), said context xₜ being one context of X specified contexts, wherein X≥2;
executing a HMM parameter transformation to compute \hat{p}ₜ, \hat{θ}ₜ, and \hat{θ}ₜ, using a conditional probability distribution p(xₜ|z,\hat{θ}ₜ₋₁) and inputs comprising xₜ or {xₜ}, \hat{p}ₜ₋₁, \hat{θ}ₜ₋₁, and \hat{ϕ}ₜ₋₁, wherein {xₜ} is x₁, x₂, . . . and xₜ.
selecting an action (aₜ) from the K actions, said action (aₜ) maximizing a function F(a) having a dependence on a reward estimate vector of dimension Z comprising the mean reward estimate \hat{μ}^{(a}^{ₜ₎} or a stochastic reward estimate vector (μ^{(a)});
sending an electromagnetic signal to a hardware machine, said electromagnetic signal directing the hardware to perform the selected action αₜ;
receiving an identification of a dynamic reward (rₜ) resulting from the hardware machine having performed the selected action aₜ;
updating the mean reward estimate \hat{μ}^{(a}^{ₜ₎} as a function of rₜ and \hat{p}ₜ; and
computing an update of the latent state probability vector \hat{p}ₜ(z) for each latent state z (z=1, 2, . . . , Z), said update of \hat{p}ₜ(z) comprising a dependence on rₜ or {rₜ}, aₜ, and \hat{μ}^{(a}^{ₜ₎}, wherein {rₜ} is r₁, r₂, . . . and rₜ.

20. A computer system, comprising one or more processors, one or more memories, and one or more computer readable hardware storage devices, said one or more hardware storage devices containing program code executable by the one or more processors via the one or more memories to implement a method for triggering actions in a sequence of time steps within a multi-armed bandit process, said method comprising:
sequentially performing, by the one or more processors, time steps t (t=0, 1, . . . , N), wherein N≥2,
wherein performing time step 0 comprises providing: an initial value \hat{p}₀ of a latent state probability vectorₜ of dimension Z respectively associated with Z specified latent states wherein Z≥2; an initial value (\hat{θ}₀,\hat{ϕ}₀) of Hidden Markov Model (HMM) parameters (\hat{θ}ₜ, \hat{ϕ}ₜ); and for each action (a) of K specified actions wherein K≥2: an initial value of a mean reward vector \hat{μ}^{(a)} of dimension Z,
wherein performing time step t (t=1, 2, . . . , N) comprises:
receiving, from an external system that is external to the computer system, a context (xₜ), said context xₜ being one context of X specified contexts, wherein X≥2;
executing a HMM parameter transformation to compute \hat{p}ₜ, \hat{θ}ₜ, and \hat{ϕ}ₜ, using a conditional probability distribution p(xₜ|z,\hat{θ}ₜ₋₁) and inputs comprising xₜ or {xₜ}, \hat{p}ₜ₋₁, \hat{θ}ₜ₋₁, and \hat{ϕ}ₜ₋₁, wherein {xₜ} is x₁, x₂, . . . and xₜ.
selecting an action (aₜ) from the K actions, said action (aₜ) maximizing a function F(a) having a dependence on a reward estimate vector of dimension Z comprising the mean reward estimate \hat{μ}^{(a}^{ₜ₎} or a stochastic reward estimate vector (μ^{(a)});
sending an electromagnetic signal to a hardware machine, said electromagnetic signal directing the hardware to perform the selected action αₜ;
receiving an identification of a dynamic reward (rₜ) resulting from the hardware machine having performed the selected action aₜ;
updating the mean reward estimate \hat{μ}^{(a}^{ₜ₎} as a function of rₜ and \hat{p}ₜ; and
computing an update of the latent state probability vector \hat{p}ₜ(z) for each latent state z (z=1, 2, . . . , Z), said update of \hat{p}ₜ(z) comprising a dependence on rₜ or {rₜ}, aₜ, and \hat{μ}^{(a}^{ₜ₎}, wherein {rₜ} is r₁, r₂, . . . and rₜ.
